(19) United States
(12) Patent Application Publication
(10) Pub. No.: US 2025/0322219 A1
(43) Pub. Date: Oct. 16, 2025

(54) NEURAL NETWORK PLATFORM AND OPERATING METHOD OF NEURAL NETWORK PLATFORM

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR)

(72) Inventors: Jung Hoon CHUN, Suwon-si (KR); Hyeonseong IM, Suwon-si (KR); Yoonmyung Lee, Suwon-si (KR)

(73) Assignees: SAMSUNG ELECTRONICS CO., LTD., Suwon-si (KR); RESEARCH & BUSINESS FOUNDATION SUNGKYUNKWAN UNIVERSITY, Suwon-si (KR)

(21) Appl. No.: 19/061,386

(22) Filed: Feb. 24, 2025

(30) Foreign Application Priority Data
Apr. 16, 2024 (KR) 10-2024-0050676

(51) Int. Cl. G06N 3/049; G06N 3/088

(52) U.S. Cl. CPC G06N 3/049; G06N 3/088

(57) ABSTRACT

A neural network platform, including: a memory array configured to store a plurality of synaptic weights corresponding to a plurality of neurons included in a plurality of memory cells; and a learning device configured to: based on a clock signal having a first logical value, perform a computation operation on the memory array using a computation module according to the plurality of synaptic weights, and based on the clock signal having a second logical value, perform a learning operation without using the plurality of synaptic weights

### CROSS-REFERENCE TO RELATED APPLICATION

This application claims priority under 35 U.S.C. § 119 from Korean Patent Application No. 10-2024-0050676, filed on Apr. 16, 2024, in the Korean Intellectual Property Office, the disclosure of which is incorporated by reference herein in its entirety.

### BACKGROUND

### 1. Field

The disclosure relates to a neural network platform and an operating method of the neural network platform.

### 2. Description of Related Art

Neuromorphic hardware may imitate the operation principles of the human brain, where numerous neurons may process and store information and perform cognitive/recognition/conscious activities by parallel transmission of electrical/chemical signals, and may perform memory and computation of vast amounts of data in parallel. In contrast, von Neumann-type hardware, which may process data sequentially when the data is input, has shown excellent performance in tasks such as simple numerical calculations and executing precisely written programs. However, von Neumann-type hardware may be less efficient in tasks such as processing and understanding images or sounds, including pattern recognition, real-time recognition, and voice recognition, in a manner similar to human analysis and comprehension, due to structural limitations such as bandwidth constraints.

### SUMMARY

One or more embodiments may address at least the problems and/or disadvantages described above, and other disadvantages not described above. Also, the embodiments are not required to overcome and may not overcome any of the problems and disadvantages described above.

Additional aspects will be set forth in part in the description which follows and, in part, will be apparent from the description, or may be learned by practice of the presented embodiments.

In accordance with an aspect of the disclosure, a neural network platform includes: a memory array configured to store a plurality of synaptic weights corresponding to a plurality of neurons included in a plurality of memory cells; and a learning device configured to: based on a clock signal having a first logical value, perform a computation operation on the memory array using a computation module according to the plurality of synaptic weights, and based on the clock signal having a second logical value, perform a learning operation without using the plurality of synaptic weights.

The memory array may be further configured to apply, to the learning device, at least one of a pre-spike corresponding to a pre-neuron and a post-spike corresponding to a post-neuron based on the clock signal.

The memory array may be further configured to: transmit a predetermined address value to the learning device; and receive a synaptic weight corresponding to the predetermined address value from the learning device.

The memory array may include a magnetic random access memory (MRAM) array.

The learning device may be further configured to: determine a variation in the plurality of synaptic weights based on a time interval between a pre-spike, in which a spike is input into the plurality of neurons through a synapse, and a post-spike, in which the spike fires and is output from the plurality of neurons; and perform the learning operation based on a spike-timing dependent plasticity (STDP) algorithm configured to modify the plurality of synaptic weights based on the determined variation.

The STDP algorithm may include: a pair-based STDP algorithm including a long-term potentiation (LTP) operation in which the plurality of synaptic weights are changed in a positive direction based on a pre-neuron from among the plurality of neurons firing earlier than a post-neuron, and a long-term depression (LTD) operation in which the plurality of synaptic weights are changed in a negative direction based on the pre-neuron firing later than the post-neuron;

a triplet-based STDP algorithm wherein the LTP operation is performed based on the neurons firing according to a first sequence of the post-neuron, the pre-neuron, and the post-neuron, and the LTD operation is performed based on the neurons firing according to a second sequence of the pre-neuron, the post-neuron, and the pre-neuron; and a minimal triplet-based STDP algorithm wherein the LTP operation is performed based on the neurons firing in the first sequence, and the LTD operation is performed based on the pre-neuron among the neurons firing later than the post-neuron.

The computation module may include at least one from among: a rank table configured to store: at least one piece of information at a rank corresponding to each of a pre-spike and a post-spike in a spiking neural network corresponding to the memory array, addresses of the memory array corresponding to each of the pre-spike and the post-spike, an occurrence time of each of the pre-spike and the post-spike, and a ratio between a variation in a weight between a previous spike time and a corresponding spike time, and a synaptic weight of each of a pre-neuron corresponding to the pre-spike and a post-neuron corresponding to the post-spike; a finite state machine (FSM) configured to generate a control signal including an enable signal and a reset signal by determining a status indicating that a computation is currently performed on the post-neuron or the pre-neuron, based on the at least one piece of information; a spike detector configured to detect whether a spike including the pre-spike and the post-spike occurs in the plurality of neurons; a clock counter configured to count a number of global clocks from a previous spike to a current spike detected by the spike detector, and to initialize a counter value to a value of zero (“0”) based on the reset signal transmitted from the FSM; a read/write driver configured to perform a read operation or a write operation on the memory array according to the control signal received from the FSM; an exponential curve computation module configured to calculate an exponential value according to a timing for STDP learning based on the at least one piece of information; and a multiplication computation module configured to calculate a new synaptic weight by performing a multiplication computation between a current synaptic weight received from the read/write driver and a ratio received from the exponential curve computation module.

The rank table may be further configured to sort and store, in ascending order of proximity from the current spike, at least one address and at least one piece of timing information corresponding to at least one neuron in which the spike occurs in the memory array.

The learning device may be further configured to: store a rank of the current spike at a first rank of the rank table based on a target address corresponding to a neuron in which the current spike occurs being found, and update the rank table by lowering ranks of values previously stored in the rank table to ranks below the first rank.

The rank table may include at least one of a rank address table configured to store an address corresponding to the spike, and a rank time table configured to store a time at which the spike occurs, the learning device may be further configured to update the rank time table by adding, to a time value stored in the rank time table, a delta time received from the clock counter, and the delta time may correspond to a time interval between the previous spike and the current spike.

The rank table further may include at least one of a pre-rank table configured to store information corresponding to the pre-spike, and a post-rank table configured to store information corresponding to the post-spike.

The spike detector may be further configured to: output a long-term depression (LTD) signal configured to cause the synaptic weight to change in a negative direction based on the detected spike being the pre-spike; and output a long-term potentiation (LTP) signal configured to cause the synaptic weight to change in a positive direction based on the detected spike being the post-spike.

The exponential curve computation module may be further configured to calculate a first ratio corresponding to the pre-neuron and a second ratio corresponding to the post-neuron by calculating an exponential function value for each clock cycle based on a generation time of each of the pre-spike and the post-spike received from the rank table, at least one from among the LTD signal and the LTP signal.

The exponential curve computation module may be further configured to: based on the LTP signal being received, perform triplet-based STDP learning based on a triplet including the post-spike, the pre-spike, and the post-spik; and based on the LTD signal being received, perform pair-based STDP learning based on a pair including the post-spike and the pre-spike.

The exponential curve computation module may include a bit shifter and a subtractor, and the exponential curve computation module may be further configured to calculate a ratio between the current synaptic weight associated with the corresponding spike time and a variation between the current synaptic weight and the previous synaptic weight associated with the previous spike time by subtracting, using the subtractor, a value obtained by bit-shifting the previous synaptic weight for each clock cycle by a time constant using the bit shifter.

The learning device may be further configured to perform a computation on a spike pair that occurs N clock cycles before the current spike, and to perform the computation, the learning device may be further configured to: access values stored in the rank table by backtracking spikes stored in the rank table from the current spike during the N clock cycles, and calculate an exponential function value using the exponential curve computation module.

The exponential curve computation module may be further configured to: by performing backtracking corresponding to both the LTP signal and the LTD signal, detect a triplet including the post-spike, the pre-spike, and the post-spike, and a pair including the post-spike and the pre-spike, in which a clock cycle matches a time stored in a post-rank table for storing information corresponding to the post-spike; and transmit a signal configured to cause the multiplication computation module to perform the multiplication computation on each of the detected triplet and the detected pair.

In accordance with an aspect of the disclosure, an operating method of a neural network platform, the operating method includes: determining whether a pre-spike occurs; updating a rank table based on the determining whether the pre-spike occurs; determining whether a clock cycle matches a time value having an n-th rank in a post-rank table configured to store information corresponding to a post-spike by controlling an exponential curve computation module to perform an exponential curve computation based on the rank table being updated;
reading a synaptic weight from a memory array based on determining that the time value having the n-th rank matches the clock cycle; calculating a variation in the synaptic weight by multiplying the read synaptic weight by a ratio value obtained from the exponential curve computation module; and writing the variation in the synaptic weight to the memory array.

In accordance with an aspect of the disclosure, an operating method of a neural network platform includes: determining whether a post-spike occurs; based on the post-spike being detected, selecting a learning algorithm based on a setting, wherein the learning algorithm is selected from among a pair-based spike-timing dependent plasticity (STDP) algorithm corresponding to a pair including a pre-spike and the post-spike, and a triplet-based STDP algorithm corresponding to a triplet including the post-spike, the pre-spike, and the post-spike; based on the pair-based STDP algorithm being selected as the learning algorithm: reading a first synaptic weight from a memory array based on whether a clock cycle matches a time value having an n-th rank in a pre-rank table configured to store information corresponding to the pre-spike; calculating a variation in the first synaptic weight by multiplying the first synaptic weight by a ratio value obtained from an exponential curve computation module; and writing the variation in the first synaptic weight to the memory array; and based on the triplet-based STDP algorithm being selected as the learning algorithm: storing a current ratio value in the pre-rank table until all of a plurality of spikes corresponding to the triplet are detected; reading a second synaptic weight from the memory array based on whether all of the plurality of spikes are detected; calculating a variation in the second synaptic weight by multiplying the second synaptic weight by a ratio value stored in the pre-rank table; and writing the variation in the second synaptic weight to the memory array.

In accordance with an aspect of the disclosure, a non-transitory computer-readable storage medium stores instructions that, when executed by a processor, cause the processor to: determine whether a pre-spike occurs; update a rank table based on the determining whether the pre-spike occurs; determine whether a clock cycle matches a time value having an n-th rank in a post-rank table configured to store information corresponding to a post-spike by controlling an exponential curve computation module to perform an exponential curve computation based on the rank table being updated; read a synaptic weight from a memory array based on determining that the time value having the n-th rank matches the clock cycle; calculate a variation in the synaptic weight by multiplying the read synaptic weight by a ratio value obtained from the exponential curve computation module; and writing the variation in the synaptic weight to the memory array.

### BRIEF DESCRIPTION OF THE DRAWINGS

The above and other aspects, features, and advantages of certain embodiments of the present disclosure will be more apparent from to the following description taken in conjunction with the accompanying drawings, in which:

FIG. 1 is a diagram illustrating an operation of a neuron module of a spiking neural network (SNN), according to an embodiment;

FIGS. 2A and 2B are diagrams illustrating a learning process according to a pair-based spike-timing dependent plasticity (STDP), according to an embodiment;

FIG. 3 is a diagram illustrating a learning process according to a pair-based STDP algorithm, a triplet-based STDP algorithm, and a minimal triplet STDP algorithm, according to an embodiment;

FIG. 4 is a diagram illustrating a structure of a neural network platform according to an embodiment;

FIG. 5 is a diagram illustrating a structure and an operation of a computation module of a learning device, according to an embodiment;

FIG. 6 is a diagram illustrating a structure and an operation of a rank table according to an embodiment;

FIG. 7 is a diagram illustrating a backtracking operation by utilizing a rank table and an exponential curve computation module, according to an embodiment;

FIGS. 8A and 8B are diagrams illustrating a structure and an operation of an exponential curve computation module, according to an embodiment;

FIG. 9 is a flowchart illustrating a long-term depression (LTD) operation of a learning device, according to an embodiment;

FIG. 10 is a flowchart illustrating a long-term potentiation (LTP) operation of a learning device, according to an embodiment;

FIG. 11 is a flowchart illustrating an operating method of a neural network platform, according to an embodiment; and

FIG. 12 is a flowchart illustrating an operating method of a neural network platform, according to an embodiment.

### DETAILED DESCRIPTION

The following detailed structural or functional description is provided as an example only and various alterations and modifications may be made to embodiments. Accordingly, the embodiments are not to be construed as limited to the disclosure and should be understood to include all changes, equivalents, or replacements within the idea and the technical scope of the disclosure.

As used herein, “A or B”, “at least one of A and B”, “at least one of A or B”, “A, B or C”, “at least one of A, B and C”, “at least one of A, B, or C”, and “one or a combination of at least two of A, B, and C,” each of which may include any one of the items listed together in the corresponding one of the phrases, or all possible combinations thereof. Terms, such as first, second, and the like, may be used herein to describe various components. Each of these terminologies is not used to define an essence, order or sequence of a corresponding component, but is instead used merely to distinguish the corresponding component from one or more other components. For example, a first component may be referred to as a second component, and similarly the second component may also be referred to as the first component.

It should be noted that if it is described that one component is “connected”,

“coupled”, or “joined” to another component, a third component may be “connected”, “coupled”, and “joined” between the first and second components, although the first component may be directly connected, coupled, or joined to the second component.

The singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms may have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments are described in detail with reference to the accompanying drawings. When describing the embodiments with reference to the accompanying drawings, like reference numerals may refer to like elements, and redundant or duplicative description related thereto may be omitted.

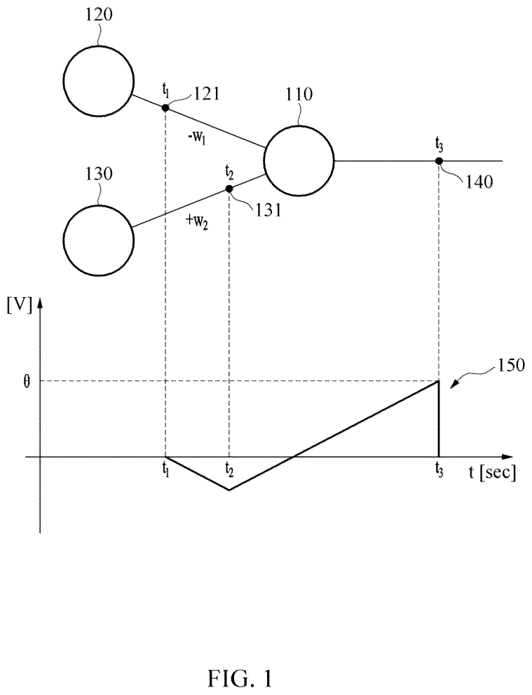

FIG. 1 is a diagram illustrating an operation of a neuron module of a spiking neural network (SNN), according to an embodiment.

The SNN may be a model that may imitate a neural network of a biological organism, and may use a realistic neuron model by imitating the mechanism of a real neuron. The SNN may form an artificial neural network by transmitting and sending a signal in the form of a spike, for example, one-bit data Similar to an operating principle of an actual biological neural network, the impact of a spike may vary depending on a weight that is set for each synapse. A synaptic weight may be updated based on the timing between spikes. The synaptic weight may be updated in various ways, for example using various synaptic weight learning rules or techniques. According to an embodiment, a spike-timing dependent plasticity (STDP) algorithm including a long-term potentiation (LTP) operation and a long-term depression (LTD) operation may be used as a synaptic weight learning rule.

The STDP algorithm may be a learning technique for adjusting the strength of synaptic connections between neurons. The strength of connections may be adjusted based on the relative timing (for example, action potential) of an output of a predetermined neuron and received input spikes. Under the STDP process, the LTP operation may be performed when an input spike to a predetermined neuron N occurs immediately before an output spike of the neuron N. Then, a predetermined input to the neuron N may be applied relatively stronger. In addition, the LTD operation may be performed when an input spike to the predetermined neuron N occurs immediately after the output spike of the neuron N. Then, the predetermined input to the neuron N may be applied relatively weaker.

The STDP algorithm may be a learning scheme based on the characteristics described above. According to the STDP algorithm, inputs that may cause excitement of a neuron that receives an input spike may be more likely to contribute in the future, while inputs that do not cause output spikes may be less likely to contribute in the future.

Here, because an input spike may be transmitted to a subsequent neuron, a neuron that generates an input spike may be referred to as a “pre-synaptic neuron” or “pre-neuron”, and a neuron that receives an input spike may be referred to as a “post-synaptic neuron” or “post-neuron”.

The STDP algorithm may be performed based on a function of a time difference or a time interval (which may be denoted t=t_{POST}−t_{PRE}) between a time (which may be denoted t_{PRE} or tᵢₙ) at which a spike occurs in a pre-synaptic neuron (e.g, a pre-neuron) and a time (which may be denoted t_{POST} or tₒᵤₜ) at which a post-synaptic neuron (e.g., a post-neuron) receives the spike, and may be effectively applied to a weight of a synapse that connects the pre-neuron to the post-neuron.

For ease of description, a time at which a spike occurs in a pre-synaptic neuron may be referred to as an “occurrence time of the pre-spike” or a “pre-spike time”. Similarly, a time at which a spike is received by a post-synaptic neuron may be referred to as a “reception time of the post-spike” or a “post-spike time”.

According to embodiments, a representative STDP graph may increase a synaptic weight based on the time difference (e.g., t=t_{POST}−t_{PRE}) between the pre-spike time and the post-spike time being positive, and may decrease the synaptic weight based one the time difference (e.g., t=t_{POST}−t_{PRE}) being negative. Examples of this are described in detail below.

In the STDP graph, a “positive time difference” may refer to a situation in which a pre-neuron fires before a post-neuron. In addition, a negative time difference may refer to a situation in which the post-neuron fires before the pre-neuron. Furthermore, increasing a synaptic weight may correspond to potentiating a synapse, while decreasing a synaptic weight may correspond to depressing a synapse.

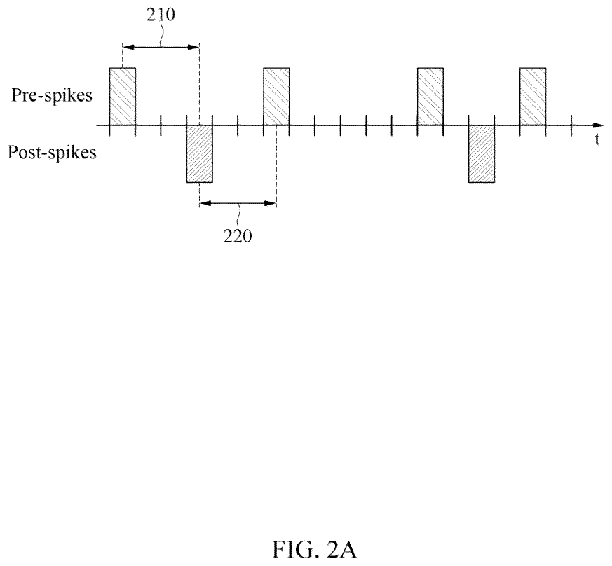

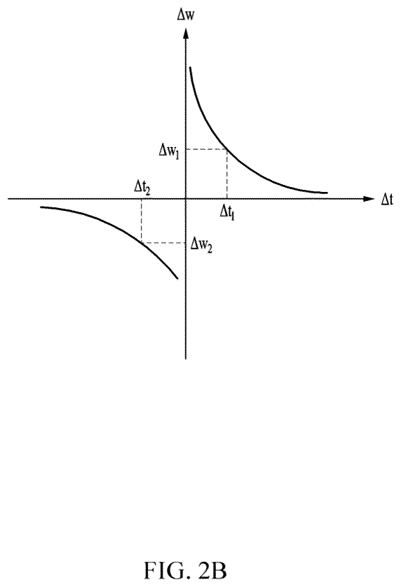

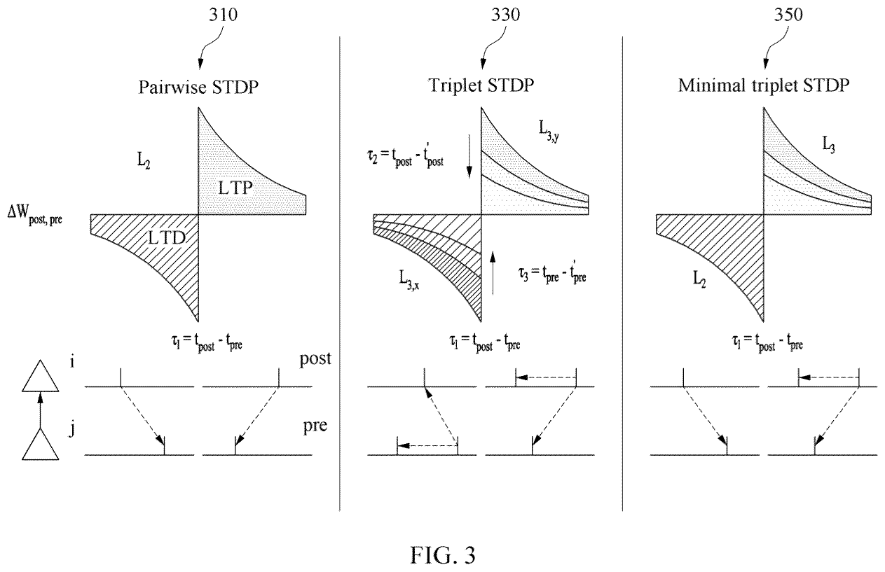

In the STDP process, a change in a synaptic weight over time may be performed based on exponential decay, examples of which are illustrated in FIG. 2B and FIG. 3, and are described in greater detail below.

Referring to FIG. 1, the SNN may include a plurality of neurons, which may include for example a first neuron 110, a second neuron 120, and a third neuron 130, connected to a synapse. For ease of description, FIG. 1 illustrates the first neuron 110 as being included in a current layer and the second neuron 120 and the third neuron 130 as being included in a previous layer. However, embodiments are not limited thereto, and different numbers of neurons may be included in various layers. For example, in some embodiments, more neurons included in various layers may be connected to a synapse to form the SNN. A neuron (e.g., the first neuron 110) included in the current layer may be referred to as a “current neuron” and a neuron (e.g., the second neuron 120 and/or the third neuron 130) included in the previous layer may be referred to as a “previous neuron”.

Furthermore, some of the plurality of neurons may be connected to another neuron in the same layer through side connection, and some of the plurality of neurons may be connected to a neuron of the previous layer again through feedback connection.

A membrane potential of the first neuron 110 may change according to a graph 150 illustrated in the bottom of FIG. 1 based on a spike of the second neuron 120 firing at a time point t₁ 121 and a spike of the third neuron 130 firing at a time point t₂ 131.

Referring to the graph 150, the membrane potential of the first neuron 110 may decrease based on the spike of the second neuron 120 firing at the time point t₁ 121 and a weight −w₁ of a connection synapse between the first neuron 110 and the second neuron 120. In addition, the membrane potential of the first neuron 110 may increase based on the spike of the third neuron 130 firing at the time point t₂ 131 and a weight +w₂ of a connection synapse between the first neuron 110 and the third neuron 130.

The first neuron 110 may fire at a time point t₃ 140 at which the membrane potential of the first neuron 110 reaches a threshold (θ), thereby generating a spike. When the spike occurs, the membrane potential of the first neuron 110 may be a value of zero (“0”). For example, the first neuron 110 may accumulate membrane potentials generated by one or more spikes received from the second neuron 120 and the third neuron 130 connected to a synapse, and may output a spike based on the accumulated membrane potentials reaching the membrane potential threshold (θ). Accordingly, the first neuron 110 may generate a maximum of one spike during the inference process for a single input.

For ease of description, based on the first neuron 110, a spike of a pre-neuron input into the first neuron 110 through a synapse may be referred to as a “pre-spike”, and a spike of a post-neuron firing, for example a spike that is output from the first neuron 110, may be referred to as a “post-spike”. A neuron may be referred to as a neuron module.

FIGS. 2A and 2B are diagrams illustrating a learning process according to a pair-based STDP algorithm, according to an embodiment.

An STDP learning process proposed herein may be implemented in the form of unsupervised on-chip learning and may be used as a learning scheme for a neuromorphic processor having an SNN. In addition, the STDP learning process may imitate a biological neural network and provide an STDP function similar to the learning principle of an actual biological neural network in a system that reproduces a biological neural network operation.

FIG. 2A illustrates an example for describing a pre-post time 210 and a post-pre time 220 used for the pair-based STDP learning process. In FIG. 2A, the upper bars may represent pre-spikes and the lower bars may represent post-spikes.

The pre-post time 210 may be a time difference obtained by subtracting the reception time of a pre-spike from the occurrence time of a post-spike when the post-spike is detected in a neuron module after the pre-spike is received by the neuron module, and may have a positive value. In addition, the post-pre time 220 may be the time difference obtained by subtracting reception time of the pre-spike when the pre-spike is received by a neuron module after the post-spike occurs in the neuron module, and may have a negative value.

FIG. 2B illustrates an example of an STDP graph which may be used for determining a weight variation based on the calculated time difference. In FIG. 2B, the x-axis of the STDP graph may represent the time difference described above. For example, a time variation Δt, and the y-axis may represent a synaptic weight variation Δw.

In the STDP graph in FIG. 2B, a time variation Δt₁ having a positive value, such as the pre-post time 210, may correspond to a weight variation Δw₁ having a positive value. Therefore, the positive weight variation Δw₁ may be determined based on the pre-post time 210. The weight variation Δw₁ may be added to a current weight of a synapse in which a pre-spike is received, so the weight of the synapse may increase. This weight increase may cause the LTP operation of the synapse.

According to the STDP graph of FIG. 2B, as the pre-post time 210 decreases, the weight variation Δw₁ may increase, and as the pre-post time 210 increases, the weight variation Δw₁ may decrease. When a post-spike occurs immediately after a pre-spike is received, indicating a high correlation between the pre-spike and the post-spike, the weight of a synapse in which the pre-spike is received may be strengthened.

A time variation Δt₂ having a negative value, such as the post-pre time 220, may correspond to a weight variation Δw₂ having a negative value. Therefore, the weight variation Δw₂ may be determined based on the post-pre time 220. The weight variation Δw₂ may be added to a current weight of a synapse in which a pre-spike is received, and the weight of the synapse may decrease.

As illustrated in the STDP graph of FIG. 2B, firing in reverse order, such as receiving a pre-spike after a post-spike occurs, may decrease the weight of a synapse receiving the pre-spike, causing the LTD operation of the synapse.

The STDP graph illustrated in FIG. 2B is provided for ease of description, but embodiments are not limited thereto. For example, in some embodiments, other STDP graphs may be utilized for determining a weight variation. According to an embodiment, a positive time variation in a predetermined interval may correspond to a negative weight variation, or vice versa.

FIG. 3 is a diagram illustrating a learning process according to a pair-based STDP algorithm, a triplet-based STDP algorithm, and a minimal triplet STDP algorithm, according to an embodiment.

FIG. 3 illustrates a diagram 310 illustrating a learning process according to the pair-based STDP algorithm, a diagram 330 illustrating a learning process according to the triplet-based STDP algorithm, and a diagram 350 illustrating a learning process according to the minimal triplet STDP algorithm.

In FIG. 3, the upper diagrams are STDP graphs showing a variation in a synaptic weight according to a time interval, and the lower diagrams are timing diagrams showing the time interval (e.g., τ₁=tₚₒₛₜ−tₚᵣₑ) between a spike (e.g., a pre-spike) of a pre-neuron, which may be a pre-synaptic neuron, and a spike (e.g., a post-spike) of a post-neuron, which may be a post-synaptic neuron.

As described above, an STDP algorithm may determine a variation in a synaptic weight based on the time interval between a pre-spike and a post-spike, and may perform learning by reflecting the determined variation on a current synaptic weight. According to embodiments, reflecting a variation on a synaptic weight may refer to modifying the synaptic weight based on, or corresponding to, the variation.

The diagram 310 corresponding to the pair-based STDP algorithm shows that as the time difference between the pre-spike and the post-spike increases, a variation in a synaptic weight may decrease exponentially. The pair-based STDP algorithm may perform an LTP operation in which the synaptic weight changes in a positive direction based on the pre-neuron being fired earlier than the post-neuron, and may perform an LTD operation in which the synaptic weight changes in a negative direction based on the pre-neuron bring fired later than the post-neuron.

In an embodiment, a triplet-based STDP algorithm may be used to imitate a learning operation of an actual biological organism more precisely instead of using a general pair-based STDP algorithm.

Referring to the diagram 330, the triplet-based STDP algorithm may perform the LTP operation based on neurons being fired according to the sequence of post-neuron, pre-neuron, post-neuron, and may perform the LTD operation based on the neurons being fired in the sequence of pre-neuron, post-neuron, pre-neuron. According to embodiments, the sequence of post-neuron, pre-neuron, post-neuron may refer to a sequence in which first the post-neuron fires, then the pre-neuron fires, and then the post-neuron fires. Similarly, according to embodiments, the sequence of pre-neuron, post-neuron, pre-neuron may refer to a sequence in which first the pre-neuron fires, then the post-neuron fires, and then the pre-neuron fires.

In addition, referring to the diagram 350, the minimal triplet STDP algorithm may perform the LTP operation similarly to the triplet-based STDP algorithm, and may perform the LTD operation similarly to the pair-based STDP algorithm. For example, the minimal triplet STDP algorithm may not perform the LTD operation based on the neurons firing in the sequence of post-neuron, pre-neuron, and post-neuron. Instead, the minimal triplet STDP algorithm may perform the LTD operation similarly to the LTD operation of the pair-based STDP algorithm, based on the neurons firing in the sequence of post-neuron and pre-neuron. Therefore, the minimal triplet STDP algorithm may perform learning using fewer variables than the triplet-based STDP algorithm, thereby enhancing hardware efficiency.

In the minimal triplet STDP algorithm, the LTP operation may correspond to learning in which a weight increases for the triplet of post-spike->pre-spike->post-spike. Herein, the term “weight” may be understood to refer to “synaptic weight”.

A weight variation ΔW according to the LTP operation may be modeled as expressed by Equation 1 below.

$$Δ W = r ( t ) [ A + B \cdot o ( t ) ] \qquad [ Equation 1 ]$$

Here, r(t) may represent a function having an exponential value between 0 and 1 according to a time interval between a pre-spike and a post-spike. In addition, o(t) may represent a function having an exponential value between 0 and 1 according to the time interval between the post-spike and the pre-spike. Further, A and B may be variables adjusted to match the results of mathematical modeling with actual biological experimental results. Rather than having precise definition as modeling parameters, A and B may have various values depending on the biological experimental results.

In addition, the LTD operation in the minimal triplet STDP algorithm may correspond to learning in which a weight for a pair of the post-spike and the pre-spike decreases. A weight variation ΔW according to the LTD operation may be modeled as expressed by Equation 2 below.

$$Δ W = A * r ( t ) \qquad [ Equation 2 ]$$

It may be possible to model synaptic weight learning in real organisms, in which shorter time intervals between spikes result in greater variations.

The weight variation ΔW obtained using the process described above may be reflected as a current synaptic weight to calculate the final weight variation. For example, even when the same time interval results in the same weight variation, based on the previously stored synaptic weight value being large, a greater weight variation may be obtained, and based on the previously stored synaptic weight value being small, a smaller weight variation may be obtained. Therefore, in an embodiment, the final weight variation may be calculated by multiplying the exponentially obtained value (e.g., r(t) and o(t)) by the previously stored synaptic weight value.

According to an embodiment, the structure of a neural network platform may implement, in addition to common pair-based STDP, triplet-based STDP and minimal triplet STDP to imitate a biological learning operation more precisely.

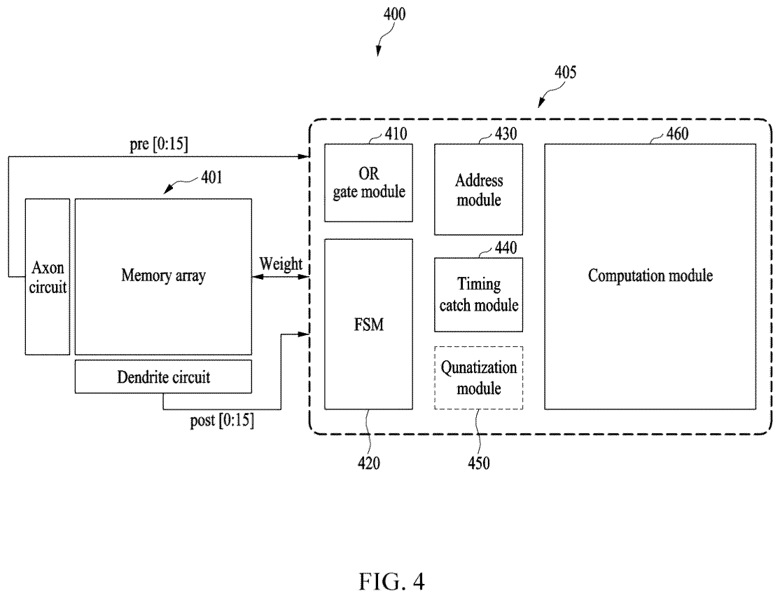

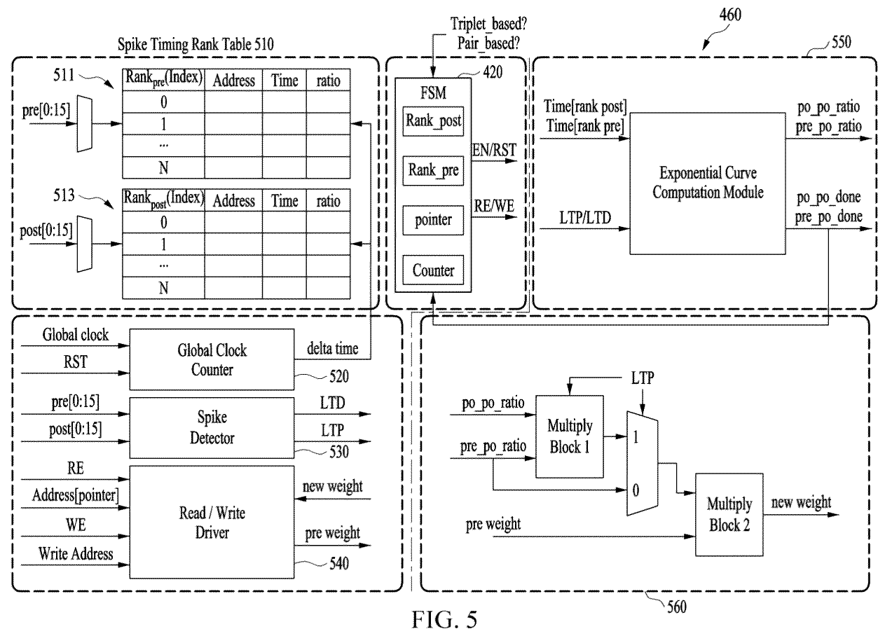

A variation in a synaptic weight may change according to the generation time interval between a pre-synaptic spike and a post-synaptic spike, the time interval between post-synaptic spikes, and the time interval between pre-synaptic spikes. According to embodiments, a generation time interval between a pre-synaptic spike and a post-synaptic spike may refer to a time interval between a time at which the pre-synaptic spike is generated and a time at which the post-synaptic spike is generated. As the time interval decreases, a value may increase exponentially. According to an embodiment, a learning device may obtain the final value by multiplying two exponentially changed values (e.g., r(t) and o(t)) to implement triplet-based STDP and calculate the final synaptic weight by reflecting the obtained final value as a ratio of a current synaptic weight. As described in detail below, the neural network platform according to an embodiment may include a multiplication computation module (e.g., a computation module 460 of FIG. 4 and/or a computation module 560 of FIG. 5) for performing a multiplication computation to calculate a variation in the final synaptic weight.

FIG. 4 is a diagram illustrating a structure of a neural network platform according to an embodiment. Referring to FIG. 4, according to an embodiment, a neural network platform 400 may include a memory array 401 implemented in a neural network device and a learning device 405 associated with the memory array 401. FIG. 4 corresponds to FIG. 5 described below, and illustrates an example of a connection relationship with a memory array.

The neural network device may be implemented as a circuit imitating a synapse connecting neuron circuits of a previous layer to neuron circuits of a target layer in a neural network (e.g., the memory array 401). An electronic device including one or more neuron circuits may be referred to as a neural network device. A neuron circuit may include a circuit configure to implement activation of a neuron and/or an activation function of the neural network (e.g., the memory array 401). The neural network (e.g., the memory array 401) may include a plurality of layers, each including a plurality of nodes, and the previous layer may be a layer before the target layer in the neural network (e.g., the memory array 401).

A node of the neural network (e.g., the memory array 401) may correspond to a neuron circuit of the neural network. The neural network device may transmit a node value (e.g., an input value) output from a neuron circuit of the previous layer to the neuron circuit of the target layer based on the strength (e.g., a synaptic weight) of connections between corresponding neuron circuits. The target neuron circuit of the target layer may have the result of applying an activation function to a weighted sum, which may be based on node values and synaptic weight values received from the previous neuron circuits of the previous layer connected to the target neuron circuit, as a node value.

Herein, the neuron circuit of the neural network device implementing an SNN may include a leaky integration and fire (LIF) circuit. However, embodiments are not limited thereto, and an activation function of the neural network may be implemented using other types of circuits and circuit designs.

The neural network platform 400 may, for example, perform a computation operation (e.g., a computation operation on the memory array 401), such as an operation using the LIF circuit, using a synaptic weight based on a global clock having a value of one (“1”) or “high” and may perform a learning operation (e.g., a learning operation of the learning device 405) without using a synaptic weight based on the global clock having a value of zero (“0”) or “low”. The learning device 405 may perform, for example, learning operations such as spike checking, timing checking, and weight evaluating. However, embodiments are not limited thereto.

The memory array 401 may include a plurality of memory cells arranged along an input line and an output line. The plurality of memory cells may be arranged in a cross bar array format. The memory array 401 may be, for example, a magnetic random access memory (MRAM) array, but embodiments are not limited thereto. Here, the input line may correspond to a line for receiving an input. The output line may output an output signal that represents the sum (e.g., a multiplication and accumulation (MAC) result or weighted sum) of the computation results (e.g., multiplication results) between the synaptic weights indicated by the resistive memory elements of the memory cells and the input values indicated by each input signal.

For example, when a synaptic weight is represented by “a” bits, each output line may include “a” bit lines. Here, “a” may be an integer greater than or equal to 1. An output signal output from one output line may be a difference signal corresponding to a difference between a signal in which column signals (e.g., bit column signals) accumulate, and a signal in which reference signals accumulate. According to embodiments, the column signals may be generated from bit lines included in the output line, and the reference signals may be generated from a reference line.

The input line may receive an input signal through a pre-synaptic circuit. The pre-synaptic circuit may receive an output of a previous node (e.g., a previous neuron circuit) of the neural network (e.g., the memory array 401) and transmit the output to a synaptic memory element of a current node. The pre-synaptic circuit may be referred to as an “axon circuit” as illustrated in FIG. 1.

The output line may be connected to a post-synaptic circuit and may transmit, to the post-synaptic circuit, a signal corresponding to MAC of input signals and the synaptic weights of synaptic memory elements connected to the output line. The post-synaptic circuit may fire or transmit an output signal corresponding to MAC of the synaptic weights and the input signals to a subsequent node (e.g., a subsequent synaptic circuit). The post-synaptic circuit may be referred to as a “dendrites circuit” illustrated in FIG. 1. The post-synaptic circuit may be implemented as an LIF circuit.

The memory array 401 may apply first information (e.g., pre[0:15]) to the learning device 405 through a pre-neuron corresponding to an axon in accordance with a global clock and apply second information (e.g., post[0:15]) to the learning device 405 through a post-neuron corresponding to dendrite. In an embodiment, the first information transmitted from the pre-neuron may be transmitted to the learning device 405 and used as information for, or corresponding to, the pre-spike, while the second information transmitted from the post-neuron may be transmitted to the learning device 405 and used as information for, or corresponding to, the post-spike.

Furthermore, the memory array 401 may transmit a predetermined address value to the learning device 405 and receive a weight corresponding to the predetermined address value from the learning device 405. The memory array 401 may perform a computation using the weight received from the learning device 405 and may write or store the final computation result in a memory element corresponding to the predetermined address.

The learning device 405 may include, for example, an OR gate module 410, a finite state machine (FSM) 420, an address module 430, a timing catch module 440, a quantization module 450, and a computation module 460. However, embodiments are not limited thereto.

The OR gate module 410 may include an OR gate and may be used to detect whether a spike occurs in neurons of the memory array 401. Here, the OR gate module 410 may perform the following two operations.

First, the OR gate module 410 may determine whether a spike exists. The OR gate module 410 may perform a bit-wise OR computation on the entire set of spikes. When there is a spike in any location, the presence of a spike may be identified or detected, thus enabling a learning block to operate.

Second, the OR gate module 410 may determine whether to perform an LTD operation or an LTP operation by performing the bit-wise OR computation on a pre-spike and a post-spike.

For example, bits respectively corresponding to the neurons of the memory array 401 may include a value of zero (“0”) when a pre-spike is not received and include a value of one (“1”) when a pre-spike is received. However, embodiments are not limited thereto, and the bits may include an opposite value as well according to an embodiment. To efficiently detect a pre-spike, the OR gate module 410 may group a certain number (e.g., n) of bits together instead of checking all the bits individually, perform a bit-wise computation (e.g., an OR computation) on each group, and then perform an operation of detecting synapses selectively received by a pre-spike only for the groups where the result value is a value of one (“1”).

The FSM 420 may determine a state of the entire system (e.g., the neural network platform 400) and indicate that a computation is currently performed on a post-neuron or a pre-neuron of a particular rank. The FSM 420 may determine that a computation is currently performed on a post-neuron or a pre-neuron of a particular rank using, for example, the rank of a post-neuron, the rank of a pre-neuron, a pointer value indicating the address of the memory array, and a counter value stored in a rank table 510 in FIG. 5. Here, the counter value may be a counter value in the FSM and may correspond to a (local) counter moving with a local clock, unlike a global counter. The counter may increase ranks one by one to sequentially explore the ranks and may be used to determine the timing of various signals. According to embodiments, the global counter may be synchronized with a global clock and may move accordingly, and may be used to count the timing of spike occurrences.

Based on a determined result, the FSM 420 may generate and/or transmit various enable signals, control signals, and/or reset (RST) signals.

The address module 430 may be a component corresponding to a rank table (e.g., the rank table 510 of FIG. 5) described below, and may store an address at which a spike occurs and update the rank table. The address module 430 may update the address of a currently occurring spike to the top of the rank table based on the occurrence of a spike being detected.

The timing catch module 440, may be a module corresponding to a global counter and may count a global clock from time at which a spike occurs until a time at which a subsequent spike occurs. The timing catch module 440 may transmit the number of clocks generated (e.g., counted) from a previous spike, for example, time (timing) information, to the address module 430 when the subsequent spike occurs while counting the global clock.

The quantization module 450 may correspond to a module for overcoming a limitation of a bit length of a synaptic weight. A synaptic weight input into a memory array may not have a large number of bits because of an area constraint. The quantization module 450 may draw an exponential function graph from an exponential curve block of a learning operation. For example, when a number of bits used is relatively small, an exponential function of a small number of stages may be expressed. Therefore, when learning, the quantization module 450 may increase the number of bits from a small number of bits to a large number of bits to obtain exponential function values of various stages and may perform quantization with a small number of bits according to the number of bits of the memory array after computation.

The computation module 460 may also be referred to as a “weight evaluation module” because the computation module 460 may perform a computation for weight evaluation. Examples of a structure and an operation of the computation module 460 are described in more detail with reference to FIG. 5.

According to an embodiment, it may be possible to apply an STDP algorithm to a neuron imitating system having the structure of the memory array 401 such that the neuron imitating system may learn a synaptic weight by itself and may imitate a learning process occurring in an actual neuron. Furthermore, by implementing triplet-based STDP, which may be more similar to the way biological organisms learn synaptic weights, in addition to pair-based STDP, which is a common STDP operation, it may be possible to imitate an operation of a real biological organism more accurately.

As described in more detail below, the learning device 405 may perform learning by reflecting a variation in a synaptic weight based on time information between spikes into a current synaptic weight. Therefore, the hardware complexity for storing and processing the time information may be high. In an embodiment, connecting a large number of synapses in an expandable array structure may improve area efficiency.

The neural network platform 400 according to an embodiment may have a spike event-driven structure, allowing high power efficiency due to spike sparsity. The neural network platform 400 may be utilized in the neural engine, neural processing unit (NPU), and/or AI fields using an SNN requiring high power efficiency and area efficiency.

FIG. 5 is a diagram illustrating a structure and an operation of a computation module of a learning device, according to an embodiment. Referring to FIG. 5, the computation module 460 may include a spike timing rank table, which may be for example a rank table 510, a clock counter 520, a spike detector 530, a read/write driver 540, the FSM 420, an exponential curve computation module 550, and a multiplication computation module 560.

In an embodiment, in a memory array structure, a ranking system may be used to reduce the time used for learning and reduce a hardware area. The rank table 510 may correspond to a register table configured to obtain a clock cycle and area efficiency using a ranking system. The rank table 510 may store various pieces of information corresponding to a timing at which a spike occurs in an SNN.

The rank table 510 may correspond to a structure for obtaining a clock cycle and area efficiency by performing a parallel computation to reduce the number of clock cycles in an array structure.

The rank table 510 may store information on the addresses and timing of one or more neurons at which a spike occurs in the memory array, in order of proximity to the present. For example, the rank table 510 may sort and store, in ascending order, spike occurrence times and the address of the memory array corresponding to spikes occurring closest in time to the current spike event

The rank table 510, to be applied to an array structure, may include two tables, for example, a table 511 for storing information corresponding to a pre-spike of a pre-neuron and a table 513 for storing information corresponding to a post-spike of a post-neuron. For ease of description, the table 511 for storing a pre-spike may be referred to as a “pre-rank table” and the table 513 for storing a post-spike may be referred to as a “post-rank table”. The rank table 510 may store a rank (or, for example, an index corresponding to the rank), the address of the memory array, a spike occurrence time, and a ratio corresponding to each of a pre-spike and a post-spike.

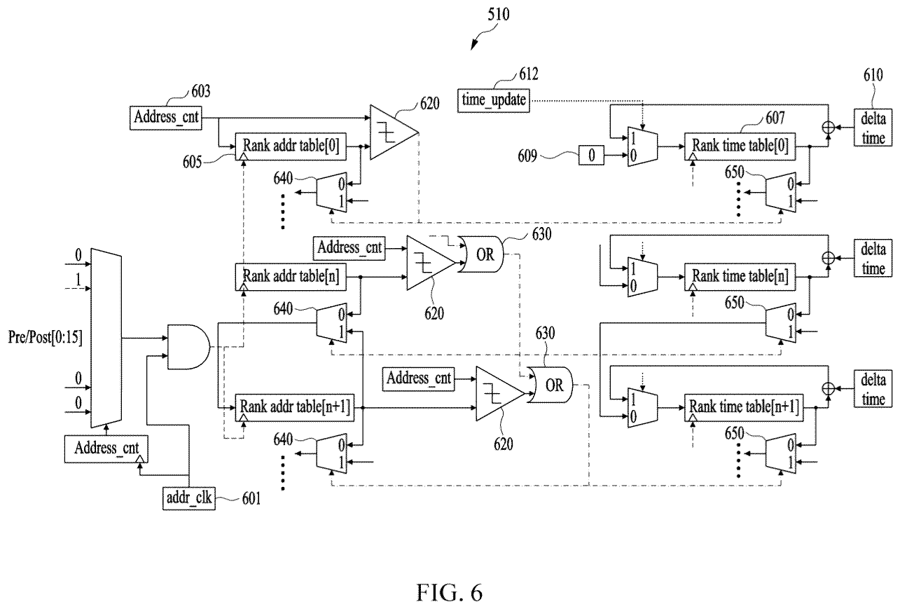

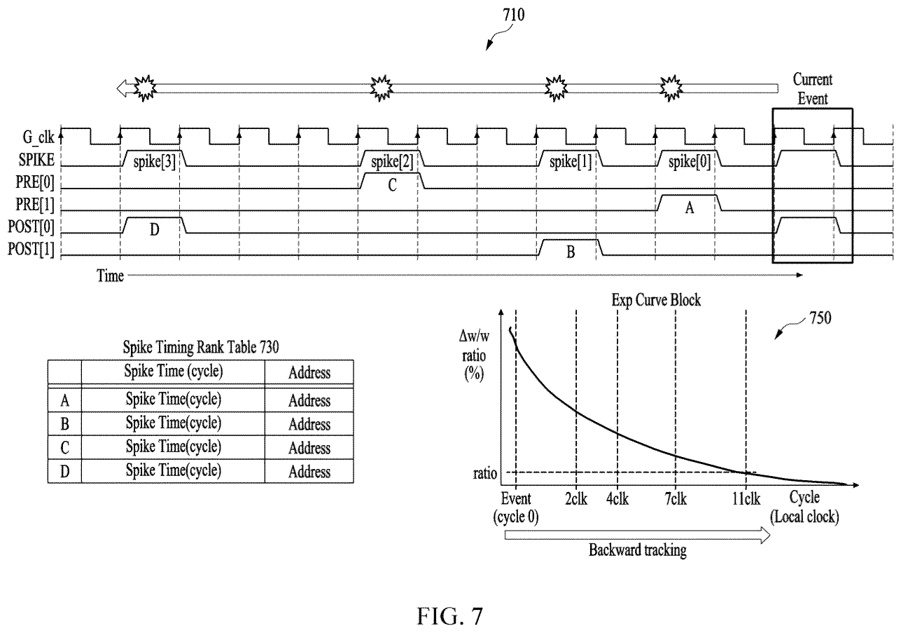

The learning device may entirely form the rank table 510, for example, in a stack format. Whenever an address corresponding to a neuron in which a spike occurs is found, the learning device may store the address as the first rank (e.g., rank 0) of the rank table 510 and may update the rank table 510 by lowering the ranks of the previously stored values (e.g, by incrementing the indexes corresponding to the ranks). In this way, the rank table 510 may enable a computation to be performed on the top critical N spikes with short time intervals from the current spike event. An example of the circuit structure and operation of the rank table 510 are described in detail with reference to FIGS. 6 and 7.

The FSM 420 may determine the state of the entire system (e.g., the neural network platform 400) and indicate that a computation is currently performed on a post-neuron/pre-neuron of a particular rank. For example, the FSM 420 may determine that a computation is currently being performed on a particular rank of post-neuron/pre-neuron using a pointer value, a counter value, and the like representing the rank of a pre-neuron, the rank of a pre-neuron, and the address of the memory array stored in the rank table 510. The FSM 420 may generate and/or transmit various enable signals, control signals, and/or RST signals according to the determined result. The FSM 420 may generate and/or transmit various enable signals, control signals, and/or RST signals based on system and user settings regarding whether to perform learning according to a pair-based STDP algorithm or perform learning according to a triplet-based STDP algorithm.

The global clock counter 520 may count the number (illustrated as “delta time”) of global clocks from a previous spike event to a current spike event. According to embodiments, the number of global clocks may refer to a number of counts or cycles of a global clock or a global clock signal. The global clock counter 520 may operate according to a global clock and an RST signal transmitted from the FSM 420. When the RST signal transmitted from the FSM 420 is a value of one (“1”), the global clock counter 520 may initialize the previously counted value to a value of zero (“0”).

The spike detector 530 may detect whether a spike occurs in neurons. The spike detector 530 may detect whether a spike occurs in the neurons using, for example, the OR gate module 410 described above.

For example, when a detected spike is a pre-spike input into a neuron through a synapse (e.g., when a pre-neuron fires before a post-neuron) the spike detector 530 may output an LTD signal that causes a synaptic weight to change in the negative direction. However, when a detected spike is a post-spike that fires and is output from a neuron (e.g., when a pre-neuron fires before a post-neuron) the spike detector 530 may output an LTP signal that causes a synaptic weight to change in the positive direction.

The LTD signal or the LTP signal output from the spike detector 530 may be transmitted to the exponential curve computation module 550. The exponential curve computation module 550 may perform an exponential curve computation corresponding to the LTD signal or the LTP signal.

In addition, the LTP signal output from the spike detector 530 may be transmitted to the multiplication computation module 560.

The read/write driver 540 may read a value from a memory array (e.g., the memory array 401 of FIG. 4) according to a read enable signal RE received from the FSM 420. The memory array may correspond to a memory array in which a synaptic weight is stored. Furthermore, the read/write driver 540 may receive both a read enable signal RE and a write enable signal WE from the FSM 420 and write a value to the memory array according to the received signal.

The exponential curve computation module 550 may calculate an exponential value according to timing used for leaning according to an STDP algorithm. The exponential curve computation module 550 may receive, from the rank table 510, a time at which a spike occurs in each of a pre-neuron and a post-neuron and may receive the LTD signal or the LTP signal output from the spike detector 530. The exponential curve computation module 550 may calculate a ratio pre_po_ratio corresponding to a pre-neuron and a ratio po_po_ratio corresponding to a post-neuron by calculating an exponential function value for each clock cycle based on received information (e.g., the time at which a spike occurs in each of the pre-neuron and the post-neuron and the LTD signal or the LTP signal). The exponential curve computation module 550 may activate a done signal (e.g., a done signal po_po_done and a done signal pre_po_done) when the time written to the rank table 510 matches the number of counted clock cycles. The exponential curve computation module 550 may allow the multiplication computation module 560 to begin a multiplication computation by transmitting, to the multiplication computation module 560, ratios (e.g., the ratio po_po_ratio and the ratio pre_po_ratio) respectively corresponding to the pre-neuron and the post-neuron.

The learning device may operate the exponential curve operation module 550 for N clock cycles to compute an exponential value for a spike pair that occurs N clocks before the current spike event. In this case, because the timing values in the rank table 510 may be already sorted in ascending order, the exponential curve computation module 550 may use a backtracking (e.g., backward tracking) approach when accessing the spikes stored in the rank table 510 from the current spike event.

For example, when the spike time of the n-th rank is denoted as A and the spike time of the (n+1)-th rank as B, instead of rewinding the clock cycles of the exponential curve computation module 550 back to A and then cycling from 0 to B, an exponential value may be calculated by repeating the clock cycles starting from the spike time A to the spike time B. In this case, the exponential curve computation module 550 may calculate the exponential value within the maximum time clock cycle of a single time window.

When receiving the LTP signal, the exponential curve computation module 550 may perform triplet-based STDP learning based on a triplet of post-spike, pre-spike, and post-spike. When receiving the LTD signal, the exponential curve computation module 550 may perform pair-based STDP learning based on a pair of post-spike and pre-spike.

Therefore, the exponential curve computation module 550 may perform backtracking corresponding to both the LTP and LTD signals, thus finding a triplet of post-spike, pre-spike, and post-spike and a pair of post-spike and pre-spike in which a clock cycle matches the time of the rank table 510 for storing post-spikes.

The exponential curve computation module 550 may transmit a done signal (e.g., the post-done signal po_po_done and the pre-done signal pre_po_done) to the multiplication computation module 560 for each of the spike triplet and the spike pair, such that a multiplication computation between a current synaptic weight (illustrated as “pre weight”) and the ratio value received from the exponential curve computation module 550 may be performed.

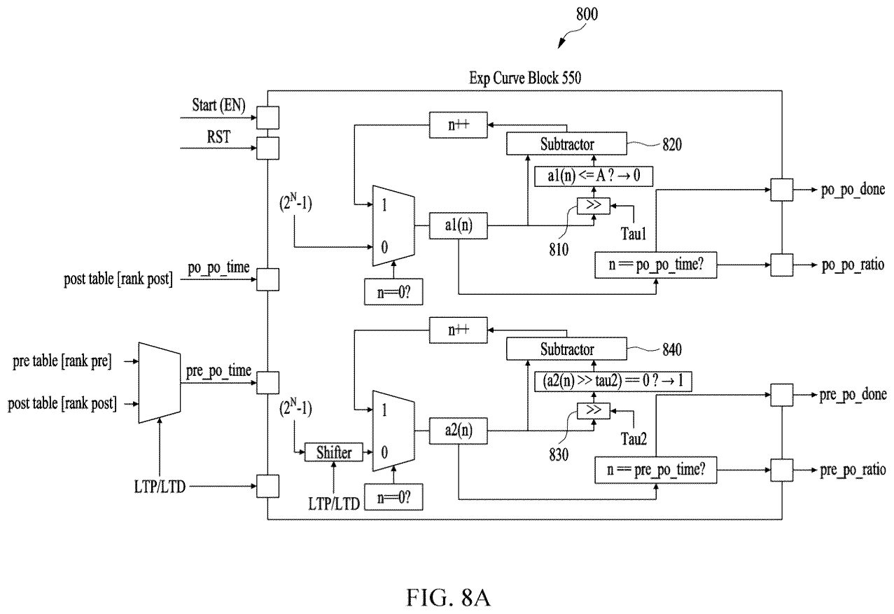

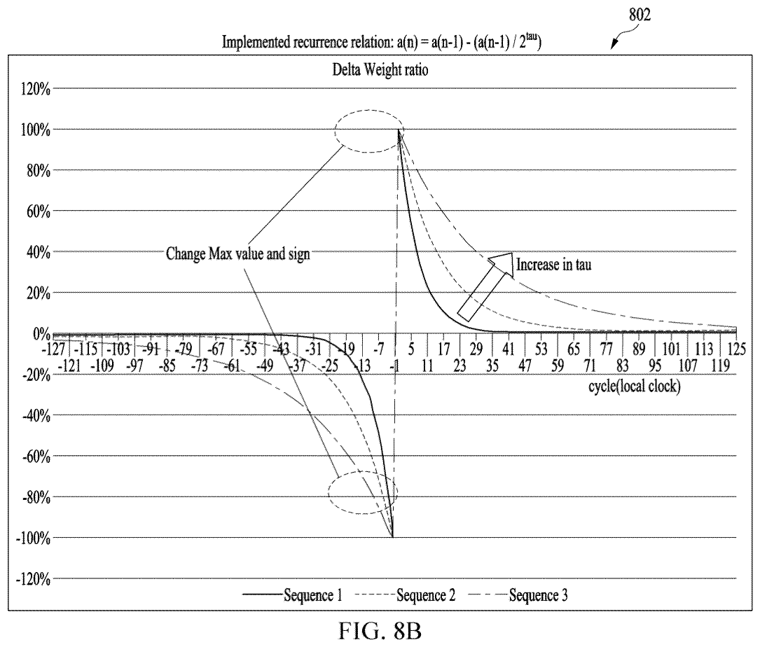

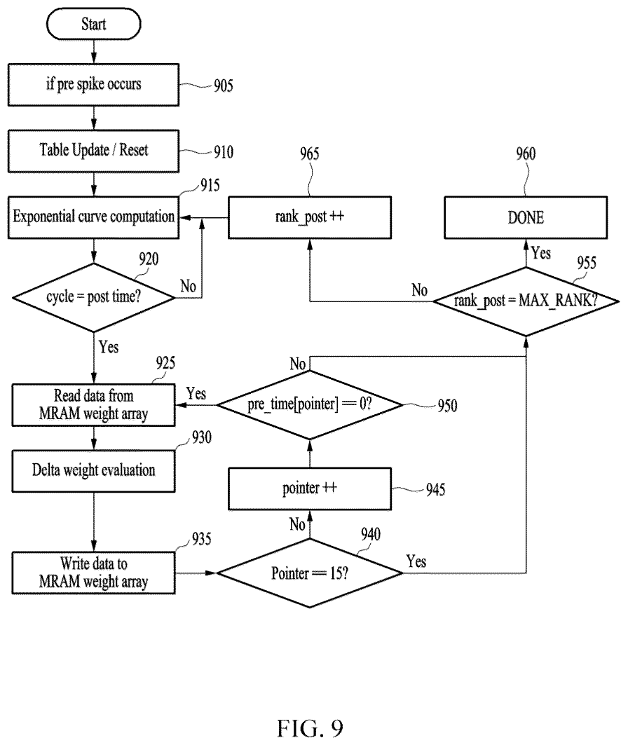

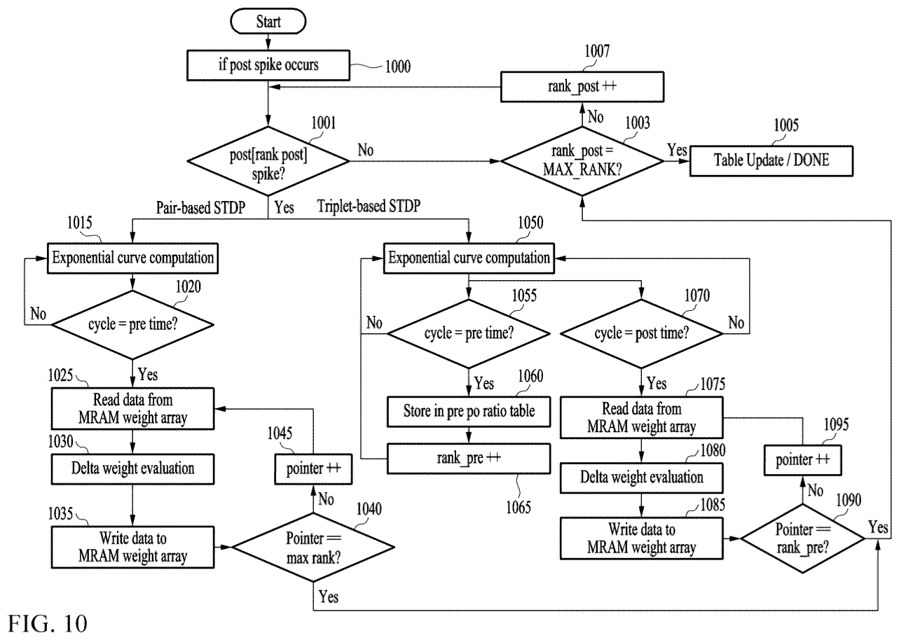

Examples of the structure and operation of the exponential curve computation module 550 are described in detail below with reference to FIGS. 8A, 8B, and 8C. In addition, an example of the process of operating a learning device according to an LTD signal is described in detail below with reference to FIG. 9, and an example of the process of operating the learning device according to an LTP signal is described in detail with reference to FIG. 10.

The multiplication computation module 560 may output a new synaptic weight (illustrated as “new weight”) by performing a multiplication computation between a current synaptic weight received from the read/write driver 540 and a ratio value received from the exponential curve computation module 550. The new synaptic weight output from the multiplication computation module 560 may be applied to the read/write driver 540 and written to a memory array.

The exponential curve computation module 550 and the multiplication computation module 560 may correspond to modules for computing a synaptic weight.

FIG. 6 is a diagram illustrating a structure and an operation of a rank table according to an embodiment. FIG. 6 illustrates a diagram showing a circuit structure of the rank table 510, according to an embodiment.

As described above, in an embodiment, for a rank system, when a spike event occurs, the rank table may be formed as a stack-like register table by raising and prioritizing the rank of a currently occurring spike event and lowering the rank of a value (e.g., information corresponding to the spike event that previously occurred) previously stored in the rank table.

The rank table 510 may receive a clock signal Addr_clk 601 from an FSM. The rank table 510, while counting addresses one by one to search for where a spike occurs according to the clock signal Addr_clk 601, may store the address value Address_cnt 603 of a neuron X in which a spike event occurs in a rank address table Rank_addr_table[0] 605) based on determining that that the spike event occurs in the neuron X corresponding to a predetermined address. In this case, the remaining values stored in the rank table 510 may be passed down one by one, causing the ranks corresponding to these remaining values to decrease to, for example, a rank addresses table[1], . . . , a rank address table[n], . . . , a rank address table [n+1].

However, when the rank address table is updated as described above, a duplicate address may be stored in the rank table. When a duplicate address is stored in the rank table, during an STDP computation, a computation on a predetermined address may be performed twice, or information with a larger time interval, meaning non-critical information, may be reflected. Therefore, in an embodiment, a comparator 620 and an OR gate 630 may be used to implement a nearest-neighbor algorithm for learning a spike event that occurs closest in time from a current spike event. The nearest-neighbor algorithm may correspond to an algorithm that learns the spike event occurring closest in time. For example, when the post-spike of neuron 5 occurs four clock cycles ago and also occurs eight clock cycles ago, according to the nearest-neighbor algorithm, information about the spike occurring four clock cycles ago may be stored in the rank table 510.

The nearest-neighbor algorithm may discover whether a neuron associated with a number corresponding to the value of an address count Address_cnt spikes as the value of the address count increases one by one. In this case, when it is detected that a spike occurs in a neuron with a predetermined number, the address information about the neuron may be stored in the address count Address_cnt.

The learning device may compare the address information about the corresponding neuron with address information stored in a current rank table using a comparator. When there is address information that is the same as the address information for the corresponding neuron, the learning device may delete the same address information stored in the rank table to prevent duplication.

For example, when the rank having an address equal to the current address count Address_cnt is denoted as A, the learning device may descend the information in the duplicate A rank to lower ranks and update the information, while the information for values after rank A may not be descended to the lower ranks. This may result in the information about the occurrence of a current spike being updated to be at the topmost rank, and the information in the upper ranks before rank A may be descended to the lower ranks and updated. In this case, the information in rank A may be not descended to the lower ranks, and the ranks below rank A may be not updated, so duplicate information may be removed. For such an operation, the OR gate module described above may be used.

As described above, before the update, the comparator at rank A may output a value of one (“1”) because the addresses may be the same. In this case, the information (e.g., the value of one (“1”)) may be used as a bit to determine whether to perform an update, (e.g., whether to receive information from the upper ranks).

Because the lower ranks below rank A may be not allowed to be updated, the learning device may receive the information (e.g., the value of one (“1”)) in rank A through the OR gate module to obtain the information (e.g., the value of one (“1”)) and avoid receiving information for the upper ranks, thereby preventing duplicate information from being stored in the rank table.

When there is duplicate information in rank A, the learning device may set a selection bit to a value of zero (“0”) for the ranks up to rank A and set the selection bit to a value of one (“1”) for the ranks after rank A, thereby avoiding updating information in the upper ranks.

Furthermore, along with the address value Address_cnt 603 corresponding to the neuron X, information corresponding to the time at which a spike event occurs in the neuron X may also be preferentially stored in a rank time table[0] 607. In this case, the [0]-th value of the rank time table may store an initialization value of zero (“0”) 609, which may be used to reset the time to a value of zero (“0”) after a spike occurs.

When updating the time table rank time table, the rank table 510 may transmit the sum of delta time 610 received from a global clock counter (e.g., the global clock counter 520 of FIG. 5) to the rank time table. As discussed above, delta time may refer to the time interval from a previous spike event to a current spike event. The rank table 510 may store information indicating how long ago a spike event occurs before the current spike event by adding the delta time 610 to a time value stored in the rank time table.

FIG. 7 is a diagram illustrating a backtracking operation using a rank table and an exponential curve computation module, according to an embodiment. FIG. 7 illustrates a diagram 710 showing that a spike event occurs in the sequence of D, C, B, and A from the past and a new spike event occurs now.

In this case, among the past spike events, the spike time D may occur in a post-neuron[0] eleven global clocks prior to the occurrence time point of the current clock event, and the spike time C may occur in a pre-neuron[0] four global clocks prior to the occurrence time point of the current clock event. Additionally, the spike time B may occur in a post-neuron[1] four global clocks prior to the occurrence time point of the current clock event, and the spike time A may occur in a pre-neuron[1] two global clocks prior to the occurrence time point of the current clock event.

Accordingly, the occurrence time (e.g., the number of clock cycles) of the previously occurring spike events and information about an address of a neuron may be stored as shown in a rank table 730.

In this case, the exponential curve computation module 550 may calculate an exponential value corresponding to the Δw/w ratio by backtracking (e.g., tracing back or tracking back) the clock cycles from the spike time A to the spike times B, C, and D, as shown in a diagram 750 because the spike time B may be already greater than or equal to the spike time A instead of backtracking the clock cycles, returning to the clock cycles to A, and going through the clock cycles from zero to B, zero to C, or zero to D. Here, W may correspond to a weight (e.g., a synaptic weight) corresponding to a corresponding spike time, and ΔW may correspond to a variation in a weight between a previous spike time and a current spike time. The Δw/w ratio may be expressed as a percentage. The exponential curve computation module 550 may calculate an exponential value within the maximum time clock cycles of a single time window. Here, the time window may refer to the maximum number of clock cycles of time used for weight learning. As a timing increases beyond a predetermined point, the level of learning may become negligible. Therefore, a learning device may set an appropriate time window to adjust the efficiency of learning. The maximum time may refer to the maximum duration that the aforementioned rank table may store information. For example, when the number of bits in a register storing a timing in a table is seven, then 2 to the power of seven (2⁷) may be defined as the maximum time that the rank table may store information. Therefore, the maximum time of the time window may refer to the maximum number of clocks that may be considered for learning.

For example, in FIG. 6, after generating a timeupdate signal time_update 612 and adding the delta time 610 to the values in the rank time table 607, the memory array addresses may be sequentially searched in sync with the clock signal addr_clk 601. In this case, it may be assumed that post-spikes occur in the neurons at the seventh, twelfth, and thirteenth addresses of a memory array.

In this case, each time the address is increased one by one, the selection bit of multiplexers (MUXes) 640 and MUXes 650, which determine what information to descend to a lower register, may be changed by a comparator 920 and an OR gate 930 in FIG. 9.

For example, when it is time to discover the neuron at the 7^{th} address while discovering the addresses of the memory array one by one, the address value of [3] address is previously 7, so a value of zero (“0”) may be written from [0] to [2], and a value of one (“1”) may be written from [3] to [max]. In this case, starting from the rank where a value of one (“1”) appears through an OR computation, in other words, starting from the rank that matches Address_cnt, a value of one (“1”) may be written for all subsequent ranks. When the selection bit of a multiplexer (MUX) is 0, information from a previous register may be retrieved and when the selection bit of the MUX is 1, the information from the previous register may not be retrieved. Thus, updates may be performed up to a register with duplicate addresses, and afterward updates may not be performed.

As a result, the seventh, twelfth, and thirteenth addresses in the memory array may be finally updated without duplication. Additionally, the rank time table may also reflect a new time, and the address at which a spike event occurs may be initialized to a value of zero (“0”).

FIGS. 8A and 8B are diagrams illustrating examples of a structure and an operation of an exponential curve computation module, according to an embodiment. FIG. 8A illustrates a diagram 800 showing an example of the structure of the exponential curve computation module 550 according to an embodiment.

The exponential curve computation module 550 may correspond to a component for obtaining an exponential value according to a timing used for STDP learning. In order to perform a computation on a spike pair that occurs N clocks before a current spike event, a learning device may calculate an exponential value by driving the exponential curve computation module 550 over N clock cycles, rather than outputting a value of a look-up table corresponding to N clock cycles. As described above, the timing of a rank table may be already sorted in ascending order. Therefore, the learning device may access the values stored in the rank table by backtracking from the current spike event.

For example, when the spike time corresponding to the N-th rank is A, the spike time A may be a spike event occurs A clock cycles before a spike event that performs a current computation. Furthermore, when the spike time corresponding to the N+1-th rank is B, the spike time B may be a spike event that occurs B clock cycles ago. Because the timings in the rank table may be sorted in ascending order, the relationship A≤B may be established.

In an embodiment, utilizing the fact that the timings in the rank table are sorted in ascending order, the exponential curve computation module 550 may backtrack the clock cycles to the spike time A to calculate the exponential value corresponding to the N-th rank. Then, immediately following this, the exponential curve computation module 550 may be operated from the spike time A to the spike time B to calculate the exponential value corresponding to the N+1 rank. Therefore, by operating the exponential curve computation module 550 for one maximum time cycle, the exponential values of the spike pairs in a memory array may be calculated. Here, the “maximum time clock cycle” may correspond to the maximum timing interval during which learning occurs.

In an embodiment, an exponential function may be used to implement minimal triplet-based STDP learning. Because the synaptic weights stored in the memory array are different, driving or controlling the exponential curve computation module 550 to calculate an exponential value by setting each weight as the starting point may require many clock cycles. Additionally, using a look-up table to prevent the need for many clock cycles may result in higher hardware costs.

In an embodiment, without using a look-up table, a recurrence relation as shown in Equation 3 below may be implemented using bit shifter 810 and bit shifter 830, and subtractor 820 and subtractor 840 included in the exponential curve computation module 550 according to clock cycles.

$$a ( n ) = a ( n - 1 ) - ( a ( n - 1 ) / {2}^{tau} ) \qquad [ Equation 3 ]$$

Here, a(n) may correspond to the result value of the n-th cycle and a(n−1) may correspond to the result value of the (n−1)-th cycle. In this context, a result value may refer to an exponential curve value.

The learning device may implement division by a power of two using the bit shifters 810 and 830. The element labeled as “tau” in Equation 3 may correspond to the portion indicating how many bits to shift for subtraction. When the value of tau is seven (“7”), the learning device may calculate a new value by subtracting the result of shifting the current value by seven bits from the current value. Shifting the current value by seven bits may be represented by a quotient obtained by dividing mathematically by 2 to the power of seven (27), as expressed in Equation 3.

The exponential curve computation module 550 may calculate a ratio by setting the value corresponding to 100% ratio (2^{N}−1) as the starting point rather than setting the current weight as the starting point.

Here, the ratio may represent the ratio between a synaptic weight (e.g., W) corresponding to a corresponding spike time and a variation (e.g., ΔW) in a weight between a previous spike time and a current spike time.

The exponential curve computation module 550 may calculate the ratio by subtracting, for example, a(n−1)−(a(n−1)/2^{tau}), using the subtractors 820 and 840, a value (e.g., (a(n−1)/2^{tau})) bit-shifted by the bit shifters 810 and 830 by a time constant value called tau, which is externally designated at each clock cycle, from a previous weight (e.g., a1(n), a2(n), or a(n−1).

The exponential curve computation module 550 may calculate an exponential ratio value at each clock cycle through a recurrence relation such as Equation 3. The exponential curve computation module 550 may transmit a done signal (e.g., the post-done signal po_po_done and the pre-done signal pre_po_done) when a clock cycle matches the time of a predetermined rank to enable a multiplication computation module to perform multiplication between the exponential ratio value calculated by the exponential curve computation module 550 and a current synaptic weight.

In an embodiment, a time constant (e.g., tau) value may be adjusted externally such that the number of shift bits may be adjusted according to the time constant value. The exponential curve computation module 550 may adjust the number of shifted bits based on the externally input time constant value to change decreasing value at each clock cycle, thereby changing a Max value and a sign in various ways, as illustrated in FIG. 8B.

Using a look-up table to obtain an exponential function value may require multiple look-up tables to apply various forms of graphs. However, in an embodiment, changing the time constant value externally by implementing the aforementioned recurrence relation may implement various forms of exponential function graphs.

For example, when the time constant value is seven (“7:”), the value obtained by shifting seven bits out of ten bits may be subtracted, so the ratio of the graph may decrease relatively slower. However, when the time constant value is smaller than seven (“7”), a bit-shifted value (e.g., the value subtracted at each clock cycle) increases, causing the ratio of the graph to decrease relatively faster.

In an embodiment, the shape of a graph 802 may be freely adjusted as the time constant (tau) value is adjusted by the exponential curve computation module 550 that implements the aforementioned recurrence relation.

In addition, when a clock cycle value matches the time of the pre-rank table 511 (illustrated as “pre_po_time”) and the time of the post-rank table 513 (illustrated as “po_po_time”), the exponential curve computation module 550 may generate pre-done and post-done signals (e.g., the pre-done signal pre_po_done and the post-done signal po_po_done), respectively, to ensure that subsequent computation operations are executed.

As described above, when a post-spike is detected, the learning device may perform an LTP operation. For example, when performing triplet-based STDP learning, the exponential curve computation module 550 may access both the pre-rank table 511 that stores pre-spikes and the post-rank table 513 that stores post-spikes. While accessing the pre-spikes stored in the pre-rank table 511, the exponential curve computation module 550 may store a ratio value corresponding to a pre-spike in a separate table when the time of the pre-spike matches a clock cycle.

When performing a computation for the triplet of post-spike, pre-spike, post-spike in an LTP operation, the match between the time of the pre-spike and the clock cycle may imply that all triplets are found. Because the triplet of post-spike, pre-spike, post-spike is not completed yet, the exponential curve computation module 550 may store a ratio value corresponding to a corresponding pre-spike until a post-spike is found.

For example, when the pre-done signal (e.g., the pre-done signal pre_po_done) occurs before the post-done signal (e.g., the post-done signal po_po_done), the exponential curve computation module 550 may store a ratio value and access a pre-rank table (e.g., a pre-spike rank table) by increasing a rank pre value one by one.

The exponential curve computation module 550 may increase a clock cycle after storing a ratio value in a separate table. When a post-spike finally occurs and a triplet of post-spike, pre-spike, post-spike is completed, the exponential curve computation module 550 may enable a multiplication computation module to perform a multiplication computation.

The exponential curve computation module 550 may calculate a new weight value by multiplying a ratio value corresponding to the occurrence time of a post-spike, a ratio value corresponding to a pre-spike time previously stored, and a current synaptic weight value.

When performing pair-based STDP, the exponential curve computation module 550 may access the pre-rank table storing the pre-spike. When the occurrence time of the pre-spike matches the clock cycle, the exponential curve computation module 550 may generate a pre-done signal pre_po_done. In this case, because the pair of pre-spike and post-spike is found, the exponential curve computation module 550 may directly perform a multiplication computation using a multiplication computation module without additional operations to store a ratio value in a separate table and may calculate a weight.

For an LTD operation, when a pre-spike occurs, the exponential curve computation module 550 may initiate the operation and backtracking starting from rank 0 by accessing the post-rank table in which post-spikes are stored. For example, when the time value at rank 0 is seven (“7”), the exponential curve computation module 550 may increase a clock cycle one by one to calculate the ratio value. Once the clock cycle reaches a value of seven (“7”), the exponential curve computation module 550 may use the ratio value to enable the multiplication computation module to perform multiplication computation. In this case, the ratio value may be a ratio value corresponding to the nearest post-spike pair from the current spike event.

Once the multiplication computation in the multiplication computation module is completed, the exponential curve computation module 550 may increase a rank by one and access the next closest post-spike from the current spike event, (e.g., the post-spike at rank 1) to calculate the ratio value. In this case, when increasing a clock cycle one by one until the increased clock cycle matches a spike time corresponding to rank 1, the exponential curve computation module 550 may perform a multiplication computation using the ratio value at the corresponding time point. Here, the ratio value at the corresponding time point may be the exponential ratio value of the second closest post-spike to the current spike event.

The exponential curve computation module 550 may obtain ratio values for all post-spikes within a clock cycle of one time window by performing a computation up to the last rank of the post-rank table in the manner described above.

FIGS. 9 and 10 may correspond to flowcharts of an operation of the entire learning device. When a pre-spike before a synapse is input, an LTD operation illustrated in FIG. 9 may be performed. When a post-spike after the synapse is input, an LTP operation illustrated in FIG. 10 may be performed.

FIG. 9 is a flowchart illustrating an LTD operation of a learning device, according to an embodiment. Referring to FIG. 9, the learning device may perform an LTD operation when a spike (e.g., a pre-spike) of a pre-neuron fires later than a spike (e.g., a post-spike) of a post-neuron through operations 905 to 965.

The learning device may begin the LTD operation when a global clock is a value of zero (“0”) or low.

At operation 905, the learning device may detect whether the pre-spike occurs. The learning device may receive an LTD signal or an LTP signal output from the spike detector 530.

At operation 910, the learning device may update or reset a rank table (e.g., a pre-rank table) according to whether the pre-spike is detected at operation 905. For example, when the pre-spike is detected at operation 905, the learning device may update the rank table at operation 910. When performing the LTD operation, the learning device may preferentially update the rank table as the pre-spike is detected. By prioritizing the update of the rank table, the learning device may reduce power consumption by decreasing the number of clock cycles. This may be achieved because the learning device may only meed to search for an address with a time value of 0 in the rank table when updating a weight, rather than searching from the beginning to the end to identify at which address the pre-spike occurs.

However, when the pre-spike is not detected at operation 905, the learning device may reset the rank table at operation 910.

When the rank table is updated at operation 910, the learning device may drive an exponential curve computation module (e.g., the exponential curve computation module 550) at operation 915. In embodiments, the learning device may drive the exponential curve module by, for example, controlling the exponential curve computation module to perform an exponential curve computation.

As the exponential curve computation module is driven, the learning device may determine whether a time value (illustrated as “post time”) of the n-th rank in a post-rank table matches a clock cycle.

When it is determined that the time value (e.g., post time) of the n-th rank in the post-rank table matches the clock cycle at operation 920, the learning device may transmit a post done signal (e.g., the done signal po_po_done), generate a CLK_READ signal and an read enable signal RE, and read data (e.g., an existing synaptic weight) from a memory array (e.g., an MRAM weight array) at operation 925.

At operation 930, the learning device may multiply the data (e.g., the existing synaptic weight) read at operation 925 by a ratio value received from the exponential curve computation module 550 using a multiplication computation module and determine (e.g., calculate) a variation (illustrated as “delta weight”) in a synaptic weight.

At operation 935, the learning device may write the variation in the synaptic weight determined (e.g., calculated) at operation 930 to the memory array. By performing an LTD operation, the learning device may write data (e.g., the variation in the synaptic weight) to the memory array through a write enable signal WE by subtracting a value from the existing synaptic weight. The LTD operation may be an operation in which the synaptic weight decreases, so the learning device may calculate an actual weight by subtracting the weight variation obtained as a result of the computation from the original synaptic weight and may write the calculated weight to the memory array through the write enable signal WE.

At operation 940, the learning device may determine whether a pointer value indicating an address of the memory array matches the maximum number (e.g., a value of fifteen (“15”)) of addresses of the memory array. When the pointer value matches the maximum number (e.g., the value of fifteen (“15”)) of addresses of the memory array at operation 940, the learning device may determine whether the rank of a post-spike reaches the maximum value MAX_RANK at operation 955. When the rank of the post-spike reaches the maximum value at operation 955, the learning device may reset signals and terminate (illustrated as “DONE”) the operation at operation 960.

When the rank of the post-spike does not reach the maximum value at operation 955, the learning device may increase the rank of the post-spike by a value of one (“1”) at operation 965 and then drive an exponential curve computation (EXP) module at operation 915.

When the pointer value does not match the maximum number (e.g., the value of fifteen (“15”)) of addresses of the memory array at operation 940, the learning device may increase the pointer value indicating the address of the memory array by a value of one (“1”) at operation 945 and determine whether a pre-spike occurrence time corresponding to the pointer value, which is increased by a value of one (“1”), is a value of zero (“0”) (illustrated as “pre_time[pointer)==0?]”) at operation 950.

When the pre-spike occurrence time corresponding to the pointer value, which is increased by a value of one (“1”), is a value of zero (“0”) at operation 950, the learning device may read data from the memory array at operation 925. The learning device may begin an operation in a clock cycle that the exponential curve computation module maintains to find the time value of the (n+1)-th rank, thereby saving the clock cycle and reducing power consumption.

When the pre-spike occurrence time corresponding to the pointer value, which is increased by a value of one (“1”), is not a value of zero (“0”) at operation 950, the learning device may perform operation 955.

FIG. 10 is a flowchart illustrating an LTP operation of a learning device, according to an embodiment. Referring to FIG. 10, the learning device may perform the LTP operation of triplet-based STDP through operations 1000 to 1095 when a spike (e.g., a post-spike) of a post-neuron fires later than a spike (e.g., a pre-spike) of a pre-neuron.

At operation 1000, the learning device may detect whether the post-spike occurs. The learning device may receive an LTD signal or an LTP signal output from the spike detector 530 and detect whether the post-spike occurs based on which signal is received.

The LTP operation may use time intervals between post-spikes occurring in post-neurons. Therefore, unlike in FIG. 9 in which the rank table is preferentially updated, the rank table may be updated at operation 1005 in which the LTP operation is completed. Similar to the LTD operation described above, the exponential curve computation module 550 may operate in the LTP operation until a post-rank time is reached.

When the post-spike is detected at operation 1000, the learning device may determine whether the post-spike reaches the post-rank time at operation 1001.

When it is determined that the post-spike does not reach the post-rank time at operation 1001, the learning device may determine whether the rank of the post-spike reaches the maximum value (illustrated as “MAX_RANK”) at operation 1003. Here, when the post-spike does not reach the post rank time, this may be understood as meaning that there is no post-spike at the address of a rank pointed to by a current FSM. In such cases, when there are no post-spikes at the address of the corresponding rank during the process of searching the rank table, the learning device may determine whether the rank value reaches the maximum rank (e.g., MAX_RANK) at operation 1003.

When the rank of the post-spike reaches the maximum value at operation 1003, the learning device may update the rank table or terminate (illustrated as “DONE”) the operation at operation 1005.

When the rank of the post-spike does not reach the maximum value at operation 1003, the learning device may continue its search. When the rank of the post-spike does not reach the maximum value, the learning device may increase the rank of the post-spike by a value of one (“1”) at operation 1007 and then determine whether the post-spike reaches the post-rank time at operation 1001.

When it is determined that the post-spike reaches the post-rank time at operation 1001, the learning device may perform different operations depending on whether a currently set STDP algorithm is a pair-based STDP algorithm or a triplet-based STDP algorithm. When the post-spike occurs and the post-spike is at the address of the rank pointed to by the current FSM, the learning device may begin a learning operation according to a currently set STDP algorithm.

To perform the pair-based STDP algorithm, it may be sufficient to find a pair of a pre-spike and a post-spike, as described above with reference to FIG. 9. Therefore, the learning device may perform the pair-based STDP algorithm through the process (e.g., operation 1030) of calculating a weight directly, without storing a value in a separate rank table in response to a pre-done signal (e.g., the pre-done signal pre_po_done). In this way, the learning device may select whether to perform the pair-based STDP algorithm or the triplet-based STDP algorithm by adjusting whether to initiate a weight computation based on which spike signal is generated during the backtracking process.

For example, when the currently set STDP algorithm is the pair-based STDP algorithm, the learning device may drive the exponential curve computation (EXP) module (e.g., the exponential curve computation module 550) at operation 1015. As the exponential curve computation module is driven, the learning device may determine whether the time value (illustrated as “pre time”) of the n-th rank in a pre-rank table matches a clock cycle at operation 1020. When it is determined that the time value (e.g., pre time) of the n-th rank in the pre-rank table does not match the clock cycle at operation 1020, the learning device may drive the exponential curve computation (EXP) module at operation 1015 until the time value (e.g., pre time) of the n-th rank of the pre-rank table matches the clock cycle.

When it is determined that the time value (e.g., pre time) of the n-th rank in the pre-rank table matches the clock cycle at operation 1020, the learning device may read data (e.g., an existing synaptic weight) from a memory array (e.g., an MRAM weight array) at operation 1025. In this case, the learning device may read the data from the memory array by generating a CLK_READ signal and an RE signal, for example.

At operation 1030, the learning device may determine a variation (delta_weight) in a synaptic weight by multiplying the data (e.g., the existing synaptic weight) read at operation 1025 by a ratio value received from the exponential curve computation module 550 using a multiplication computation module.

At operation 1035, the learning device may write the variation in the synaptic weight determined at operation 1030 to the memory array. In this case, since the learning device performs an LTP operation, the learning device may write the data (e.g., the variation in the synaptic weight) to the memory array through a WE signal by subtracting a value from the existing synaptic weight. Here, “subtracting a value from the existing synaptic weight to write the data (e.g., the variation in the synaptic weight)” may be understood that in the case of the LTP operation, which involves learning in which a synaptic weight increases from the current synaptic weight, the variation in the synaptic weight resulting from the operation is added to the current synaptic weight to calculate the final synaptic weight, and the calculated value is reflected in the memory array via the WE signal.

When the writing to the memory array is completed, the learning device may determine whether a pointer value matches the maximum rank (max rank) at operation 1040. When the pointer value does not match the maximum rank at operation 1040, the learning device may increase the pointer value indicating an address of the memory array by a value of one (“1”) at operation 1045 and then read the data (e.g., the existing synaptic weight) from the memory array (e.g., the MRAM weight array) corresponding to the pointer value increased at operation 1025.

When the pointer value matches the maximum rank at operation 1040, the learning device may update a rank table or terminate (Done) the operation at operation 1005 depending on whether the rank of the post-spike reaches the maximum value (MAX_RANK).

Alternatively, for example, when the currently set STDP is the triplet-based STDP algorithm, the learning device may drive the exponential curve computation (EXP) module (e.g., the exponential curve computation module 550) at operation 1050.

When the currently set STDP is the triplet-based STDP algorithm, unlike LTD operation, during the execution of the exponential curve computation module 550, a clock cycle may reach the pre-rank time. Therefore, the learning device may determine whether the clock cycle reaches the pre-rank time either along with operation 1070 or before operation 1070, through operation 1055.

At operation 1055, the learning device may determine whether the clock cycle reaches the pre rank time.

When it is determined that the clock cycle does not reach the pre-rank time at operation 1055, the learning device may perform operation 1050.

When it is determined that the clock cycle reaches the pre-rank time at operation 1055, the learning device may store a corresponding ratio value (e.g., pre po ratio) in the pre-rank table according to a pre-done signal at operation 1060. This is to ensure that the ratio value is stored until the triplet of post-spike, pre-spike, post-spike is found, as described above. Once the storing process is completed for the pre-rank table, the learning device may increase the rank value of the pre-spike by a value of one (“1”) at operation 1065 and then perform operation 1050.

Furthermore, as the exponential curve computation module is driven at operation 1050, the learning device may determine whether the clock cycle matches the time value (e.g., pre time) of the n-th rank in the pre-rank table at operation 1055 and whether the clock cycle matches the time value (e.g., pre time) of the n-th rank in the post-rank table at operation 1070.

At operation 1070, the learning device may also determine whether the time value (illustrated as “post time”) of the n-th rank in the post rank table matches the clock cycle. The occurrence of a post-done signal (e.g., the post-done signal po_po_done), where the time value (e.g., post time) of the n-th rank in the post-rank table matches the clock cycle, may correspond to a case in which the triplet of post-spike, pre-spike, post-spike is found. In this case, the learning device may sequentially perform operation 1075 of reading data, operation 1080 of calculating a weight, and operation 1085 of writing weight calculation results, similar to the LTD operation. When the operations on the triplet are completed, the exponential curve computation module may be driven to find the next pair.

For example, when it is determined that the time value (e.g., post time) of the n-th rank of the post-rank table does not match the clock cycle at operation 1070, the learning device may drive the exponential curve computation (EXP) module at operation 1050 until the time value (e.g., post time) of the n-th rank of the post-rank table matches the clock cycle.

When it is determined that the time value (e.g., post time) of the n-th rank of the post-rank table matches the clock cycle at operation 1070, the learning device may read data (e.g., the existing synaptic weight) from the memory array (e.g., the MRAM weight array) at operation 1075. The learning device may read the data from the memory array by generating the CLK_READ signal and the read enable signal RE, for example.

At operation 1080, the learning device may determine the variation (e.g., delta weight) in the synaptic weight by multiplying the data (e.g., the existing synaptic weight) read at operation 1075 by a ratio value received from the exponential curve computation module using the multiplication computation module.

At operation 1085, the learning device may write the variation in the synaptic weight determined at operation 1080 to the memory array. Because the learning device performs the LTP operation, the learning device may write the data (e.g., the variation in the synaptic weight) to the memory array through the write enable signal WE by subtracting a value from the existing synaptic weight.

When the writing to the memory array is completed at operation 1085, the learning device may determine whether the pointer value matches the pre-rank at operation 1090. When the pointer value does not match the pre-rank at operation 1090, the learning device may increase the pointer value indicating the address of the memory array by a value of one (“1”) at operation 1095 and read the data (e.g., the existing synaptic weight) from the memory array (e.g., the MRAM weight array) corresponding to the pointer value increased at operation 1075.

When the pointer value matches the maximum rank at operation 1090, the learning device may determine whether the rank (e.g., a post rank) of the post-spike reaches the maximum rank (e.g., MAX_RANK) at operation 1003. When there are no more fired post addresses or when the post-rank reaches the maximum rank, the learning device may finally update the rank-table through operation 1005 and terminate the operation.

When the rank (e.g., the post rank) of the post-spike does not reach the maximum rank (MAX_RANK) at operation 1003, the learning device may increase the rank (e.g., post rank) of the post-spike by a value of one (“1”) at operation 1007 and then determine whether the post-spike reaches the post-rank time at operation 1001.

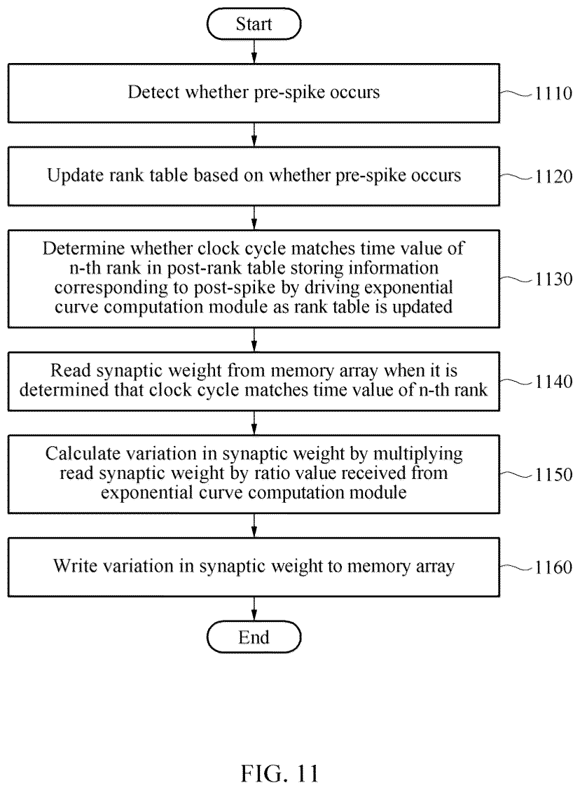

FIG. 11 is a flowchart illustrating an operating method of a neural network platform, according to an embodiment. Referring to FIG. 11, the neural network platform (more particularly, a learning device) may write a variation in a synaptic weight to a memory array through operations 1110 to 1160.

At operation 1110, the neural network platform may detect whether a pre-spike occurs.

At operation 1120, the neural network platform may update a rank table based on whether the pre-spike occurs at operation 1110.

At operation 1130, as the rank-table is updated at operation 1120, the neural network platform may determine whether a clock cycle (e.g., a value of a clock signal) matches the time value of the n-th rank in a post-rank table for storing information corresponding to the post-spike by driving an exponential curve computation module.

When it is determined that the time value of the n-th rank matches the clock cycle at operation 1130, the neural network platform may read the synaptic weight from the memory array at operation 1140.

At operation 1150, the neural network platform may calculate the variation in the synaptic weight by multiplying the synaptic weight read at operation 1140 by a ratio value received from the exponential curve computation module.

At operation 1160, the neural network platform may write the variation in the synaptic weight calculated at operation 1150 to the memory array.

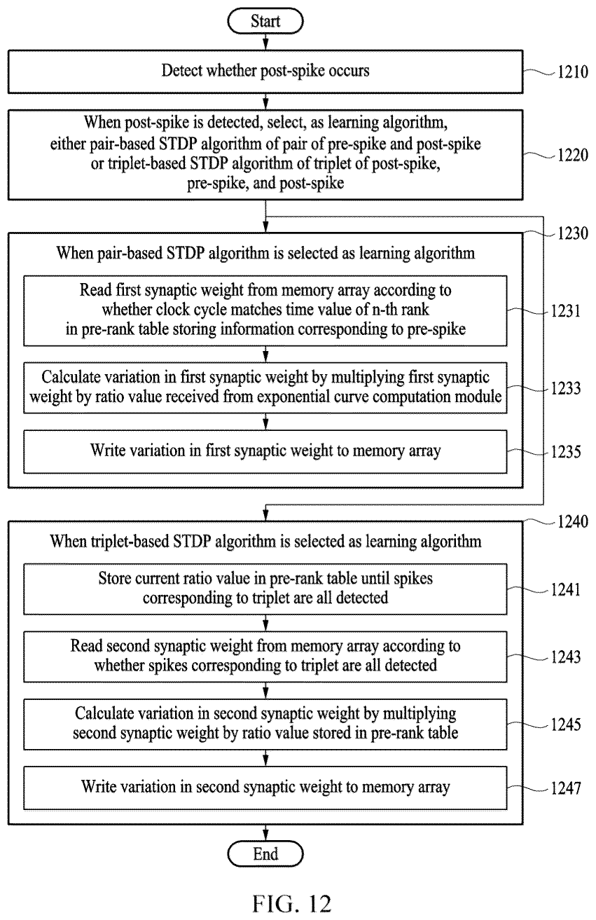

FIG. 12 is a flowchart illustrating an operating method of a neural network platform, according to an embodiment. Referring to FIG. 12, the neural network platform (e.g., a learning device) according to an embodiment may write a variation in a synaptic weight to a memory array through operations 1210 to 1247.

At operation 1210, the neural network platform may detect whether a post-spike occurs.

At operation 1220, when the post-spike occurs, the neural network platform may select, as a learning algorithm, either a pair-based STDP algorithm based on a pair including a pre-spike and a post-spike, or a triplet-based STDP algorithm based on a triplet including a post-spike, a pre-spike, and a post-spike, according to a setting.

When the pair-based STDP algorithm is selected as the learning algorithm at operation 1220, the neural network platform may perform operation 1230 including operations 1231 to 1235.

At operation 1231, the neural network may read a first synaptic weight from the memory array according to whether a clock cycle matches the time value of the n-th rank in a pre-rank table for storing information corresponding to the pre-spike.

At operation 1233, the neural network platform may calculate a variation in the first synaptic weight by multiplying the first synaptic weight read at operation 1231 by a ratio value received from an exponential curve computation module.

At operation 1235, the neural network platform may write the variation in the first synaptic weight calculated at operation 1233 to the memory array.

At operation 1220, when the triplet-based STDP algorithm is selected as the learning algorithm, the neural network platform may read a second synaptic weight from the memory array according to whether the clock cycle matches the time value of the n-th rank in the post-rank table corresponding to the post-spike.

At operation 1220, when the triplet-based STDP algorithm is determined as the learning algorithm, the neural network platform may perform operation 1240 including operations 1241 to 1247, for example.

At operation 1241, the neural network platform may store a current ratio value in the pre-rank table until all of a plurality of spikes corresponding to a triplet are detected.

At operation 1243, the neural network platform may read the second synaptic weight from the memory array according to whether all of the plurality of spikes corresponding to the triplet are detected.

At operation 1245, the neural network may calculate a variation in the second synaptic weight by multiplying the second synaptic weight read at operation 1243 by the ratio value stored in the pre-rank table.

At operation 1247, the neural network platform may write the variation in the second synaptic weight calculated at operation 1245 to the memory array.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the processing device is described as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and/or digital versatile discs (DVDs); magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A neural network platform comprising:
a memory array configured to store a plurality of synaptic weights corresponding to a plurality of neurons included in a plurality of memory cells; and
a learning device configured to:
based on a clock signal having a first logical value, perform a computation operation on the memory array using a computation module according to the plurality of synaptic weights, and
based on the clock signal having a second logical value, perform a learning operation without using the plurality of synaptic weights.

2. The neural network platform of claim 1, wherein the memory array is further configured to apply, to the learning device, at least one of a pre-spike corresponding to a pre-neuron and a post-spike corresponding to a post-neuron based on the clock signal.

3. The neural network platform of claim 1, wherein the memory array is further configured to:
transmit a predetermined address value to the learning device; and
receive a synaptic weight corresponding to the predetermined address value from the learning device.

4. The neural network platform of claim 1, wherein the memory array comprises a magnetic random access memory (MRAM) array.

5. The neural network platform of claim 1, wherein the learning device is further configured to:
determine a variation in the plurality of synaptic weights based on a time interval between a pre-spike, in which a spike is input into the plurality of neurons through a synapse, and a post-spike, in which the spike fires and is output from the plurality of neurons; and
perform the learning operation based on a spike-timing dependent plasticity (STDP) algorithm configured to modify the plurality of synaptic weights based on the determined variation.

6. The neural network platform of claim 5, wherein the STDP algorithm comprises:
a pair-based STDP algorithm comprising a long-term potentiation (LTP) operation in which the plurality of synaptic weights are changed in a positive direction based on a pre-neuron from among the plurality of neurons firing earlier than a post-neuron, and a long-term depression (LTD) operation in which the plurality of synaptic weights are changed in a negative direction based on the pre-neuron firing later than the post-neuron;
a triplet-based STDP algorithm wherein the LTP operation is performed based on the neurons firing according to a first sequence of the post-neuron, the pre-neuron, and the post-neuron, and the LTD operation is performed based on the neurons firing according to a second sequence of the pre-neuron, the post-neuron, and the pre-neuron; and
a minimal triplet-based STDP algorithm wherein the LTP operation is performed based on the neurons firing in the first sequence, and the LTD operation is performed based on the pre-neuron among the neurons firing later than the post-neuron.

7. The neural network platform of claim 1, wherein the computation module comprises at least one from among:
a rank table configured to store:
at least one piece of information at a rank corresponding to each of a pre-spike and a post-spike in a spiking neural network corresponding to the memory array,
addresses of the memory array corresponding to each of the pre-spike and the post-spike,
an occurrence time of each of the pre-spike and the post-spike, and
a ratio between a variation in a weight between a previous spike time and a corresponding spike time, and a synaptic weight of each of a pre-neuron corresponding to the pre-spike and a post-neuron corresponding to the post-spike;
a finite state machine (FSM) configured to generate a control signal comprising an enable signal and a reset signal by determining a status indicating that a computation is currently performed on the post-neuron or the pre-neuron, based on the at least one piece of information;
a spike detector configured to detect whether a spike comprising the pre-spike and the post-spike occurs in the plurality of neurons;
a clock counter configured to count a number of global clocks from a previous spike to a current spike detected by the spike detector, and to initialize a counter value to a value of zero (“0”) based on the reset signal transmitted from the FSM;
a read/write driver configured to perform a read operation or a write operation on the memory array according to the control signal received from the FSM;
an exponential curve computation module configured to calculate an exponential value according to a timing for STDP learning based on the at least one piece of information; and
a multiplication computation module configured to calculate a new synaptic weight by performing a multiplication computation between a current synaptic weight received from the read/write driver and a ratio received from the exponential curve computation module.

8. The neural network platform of claim 7, wherein the rank table is further configured to sort and store, in ascending order of proximity from the current spike, at least one address and at least one piece of timing information corresponding to at least one neuron in which the spike occurs in the memory array.

9. The neural network platform of claim 7, wherein the learning device is further configured to:
store a rank of the current spike at a first rank of the rank table based on a target address corresponding to a neuron in which the current spike occurs being found, and
update the rank table by lowering ranks of values previously stored in the rank table to ranks below the first rank.

10. The neural network platform of claim 7, wherein the rank table comprises at least one of a rank address table configured to store an address corresponding to the spike, and a rank time table configured to store a time at which the spike occurs,
wherein the learning device is further configured to update the rank time table by adding, to a time value stored in the rank time table, a delta time received from the clock counter, and
wherein the delta time corresponds to a time interval between the previous spike and the current spike.

11. The neural network platform of claim 7, wherein the rank table further comprises at least one of a pre-rank table configured to store information corresponding to the pre-spike, and a post-rank table configured to store information corresponding to the post-spike.

12. The neural network platform of claim 7, wherein the spike detector is further configured to:
output a long-term depression (LTD) signal configured to cause the synaptic weight to change in a negative direction based on the detected spike being the pre-spike; and
output a long-term potentiation (LTP) signal configured to cause the synaptic weight to change in a positive direction based on the detected spike being the post-spike.

13. The neural network platform of claim 12, wherein the exponential curve computation module is further configured to calculate a first ratio corresponding to the pre-neuron and a second ratio corresponding to the post-neuron by calculating an exponential function value for each clock cycle based on a generation time of each of the pre-spike and the post-spike received from the rank table, at least one from among the LTD signal and the LTP signal.

14. The neural network platform of claim 13, wherein the exponential curve computation module is further configured to:
based on the LTP signal being received, perform triplet-based STDP learning based on a triplet comprising the post-spike, the pre-spike, and the post-spike; and
based on the LTD signal being received, perform pair-based STDP learning based on a pair comprising the post-spike and the pre-spike.

15. The neural network platform of claim 7, wherein the exponential curve computation module comprises a bit shifter and a subtractor, and
wherein the exponential curve computation module is further configured to calculate a ratio between the current synaptic weight associated with the corresponding spike time and a variation between the current synaptic weight and the previous synaptic weight associated with the previous spike time by subtracting, using the subtractor, a value obtained by bit-shifting the previous synaptic weight for each clock cycle by a time constant using the bit shifter.

16. The neural network platform of claim 7, wherein the learning device is further configured to perform a computation on a spike pair that occurs N clock cycles before the current spike, and
wherein to perform the computation, the learning device is further configured to:
access values stored in the rank table by backtracking spikes stored in the rank table from the current spike during the N clock cycles, and
calculate an exponential function value using the exponential curve computation module.

17. The neural network platform of claim 12, wherein the exponential curve computation module is further configured to:
by performing backtracking corresponding to both the LTP signal and the LTD signal, detect a triplet comprising the post-spike, the pre-spike, and the post-spike, and a pair comprising the post-spike and the pre-spike, in which a clock cycle matches a time stored in a post-rank table for storing information corresponding to the post-spike; and
transmit a signal configured to cause the multiplication computation module to perform the multiplication computation on each of the detected triplet and the detected pair.

18. An operating method of a neural network platform, the operating method comprising:
determining whether a pre-spike occurs;
updating a rank table based on the determining whether the pre-spike occurs;
determining whether a clock cycle matches a time value having an n-th rank in a post-rank table configured to store information corresponding to a post-spike by controlling an exponential curve computation module to perform an exponential curve computation based on the rank table being updated;
reading a synaptic weight from a memory array based on determining that the time value having the n-th rank matches the clock cycle;
calculating a variation in the synaptic weight by multiplying the read synaptic weight by a ratio value obtained from the exponential curve computation module; and
writing the variation in the synaptic weight to the memory array.

19. An operating method of a neural network platform, the operating method comprising:
determining whether a post-spike occurs;
based on the post-spike being detected, selecting a learning algorithm based on a setting, wherein the learning algorithm is selected from among a pair-based spike-timing dependent plasticity (STDP) algorithm corresponding to a pair comprising a pre-spike and the post-spike, and a triplet-based STDP algorithm corresponding to a triplet comprising the post-spike, the pre-spike, and the post-spike;
based on the pair-based STDP algorithm being selected as the learning algorithm:
reading a first synaptic weight from a memory array based on whether a clock cycle matches a time value having an n-th rank in a pre-rank table configured to store information corresponding to the pre-spike;
calculating a variation in the first synaptic weight by multiplying the first synaptic weight by a ratio value obtained from an exponential curve computation module; and
writing the variation in the first synaptic weight to the memory array; and
based on the triplet-based STDP algorithm being selected as the learning algorithm:
storing a current ratio value in the pre-rank table until all of a plurality of spikes corresponding to the triplet are detected;
reading a second synaptic weight from the memory array based on whether all of the plurality of spikes are detected;
calculating a variation in the second synaptic weight by multiplying the second synaptic weight by a ratio value stored in the pre-rank table; and
writing the variation in the second synaptic weight to the memory array.

20. A non-transitory computer-readable storage medium storing instructions that, when executed by a processor, cause the processor to:
determine whether a pre-spike occurs;
update a rank table based on the determining whether the pre-spike occurs;
determine whether a clock cycle matches a time value having an n-th rank in a post-rank table configured to store information corresponding to a post-spike by controlling an exponential curve computation module to perform an exponential curve computation based on the rank table being updated;
read a synaptic weight from a memory array based on determining that the time value having the n-th rank matches the clock cycle;
calculate a variation in the synaptic weight by multiplying the read synaptic weight by a ratio value obtained from the exponential curve computation module; and
writing the variation in the synaptic weight to the memory array.
